(19) United States
(12) Patent Application Publication
(10) Pub. No.: US 2012/0050349 A1
(43) Pub. Date: Mar. 1, 2012

(54) CONTROL DEVICE, DISPLAY DEVICE, METHOD OF CONTROLLING DISPLAY DEVICE

(75) Inventors: Yusuke YAMADA, Matsumoto-shi (JP); Kota MUTO, Suwa-shi (JP); Masato NISHIZAWA, Shiojiri-shi (JP)

(73) Assignee: SEIKO EPSON CORPORATION, Tokyo (JP)

(21) Appl. No.: 13/219,177

(22) Filed: Aug. 26, 2011

(30) Foreign Application Priority Data
Aug. 31, 2010 (JP) 2010-194905

(51) Int. Cl. G09G 5/10

(52) U.S. Cl. 345/690

(57) ABSTRACT

A display device changes the gray scale of a pixel by performing a write operation in which a voltage is applied to the pixel a plurality of times. In a case where the display state of the pixel is changed based on image data written into a memory, the display device determines whether or not the pixel of which the display state is changed is in the middle of the write operation. The display device starts the write operation for the pixel that is not in the middle of the write operation. On the other hand, for the pixel that is in the middle of the write operation, the display device, after completion of the write operation that is in the middle of the process, starts a new write operation for the pixel so as to have a gray scale determined based on the image data.

### BACKGROUND

1. Technical Field

The present invention relates to a control device, a display device, and a method of controlling a display device.

2. Related Art

As display devices that display images, there are electrophoretic display devices using microcapsules. In such display devices of an active matrix system, a driving circuit that drives a microcapsule is disposed at each intersection of a plurality of row electrodes extending in the row direction and a plurality of column electrodes extending in the column direction. When a voltage is applied to the row electrodes and the column electrodes, an electric potential difference is generated between an electrode disposed in the driving circuit and an electrode opposing this electrode with a microcapsule interposed therebetween. When an electric potential difference is generated between opposing electrodes with a microcapsule interposed therebetween, white particles and black particles disposed inside the microcapsule move in accordance with an electric field that is generated by the electric potential difference. As the distribution of the white particles and the black particles disposed inside each microcapsule changes, the optical reflection characteristics change, whereby an image is displayed.

In the electrophoretic display devices, when a display is changed in an active matrix system, rewriting of an image may be performed over a plurality of frames. However, in a case where rewriting of the entire screen is started when the rewriting of an image is performed over a plurality of frames, new writing cannot be performed until the writing is completed. Accordingly, in order to record or remove an image, the next writing is started after writing of an image is completed, and there is a problem from the viewpoint of the operability in that it takes time.

Thus, in order to solve such a problem, a system is devised in which writing is performed by performing a pipeline process in units of partial areas (see JP-A-2009-251615). According to the system disclosed in JP-A-2009-251615, in a case where an image is written in two partial areas of a screen that do not overlap each other at delayed timing, even when the writing of the image in a partial area for which writing is started first is not completed, writing of the image in a partial area for which writing is started later can be started. Therefore, a display speed is higher than that in a case where such a system is not employed.

However, in a system disclosed in JP-A-2009-251615, when the partial areas overlap each other in part, consequently, writing of the image in the partial area for which writing is started later needs to wait until the writing of the image in the partial area for which the writing has been started first is completed. Accordingly, it takes time to complete the display.

### SUMMARY

An advantage of some aspects of the invention is that it provides improvement in the perceived display speed of the electrophoretic display device.

According to an aspect of the invention, there is provided a control device for a display device in which each of a plurality of pixels is configured by a first electrode, a display element, and a second electrode by interposing the display element between a first substrate in which the first electrodes are disposed and a second substrate in which the second electrodes are disposed in correspondence with the plurality of pixels. A gray scale of the pixel is changed by a write operation in which a voltage is applied to the pixel a plurality of times, and, within one frame period, a voltage is applied to a first pixel, of which a gray scale is changed to a high density side, with the first electrode of the first pixel being set to one of positive polarity and negative polarity with respect to the second electrode, and a voltage is applied to a second pixel, of which a gray scale is changed to a low density side, with the first electrode of the second pixel being set to polarity opposite to the one of positive polarity and negative polarity with respect to the second electrode. The control device includes: a specifying unit that specifies change pixels, of which gray scales are changed, among the plurality of pixels by comparing image data written into a memory and provisional image data representing a provisional image to be displayed on the display device by the write operation that is in the middle of the process; and an update unit that starts the write operation for the change pixel so as to have a gray scale determined based on the image data in a case where the change pixel is not in the middle of the process of the write operation, and, after completion of the write operation that is in the middle of the process, starts the write operation for the change pixel so as to have a gray scale determined based on the image data in a case where the change pixel is in the middle of the process of the write operation.

According to this control device, the write operation is immediately started for a pixel, of which the gray scale is to be changed, that is not in the middle of the write operation, and whereby a sensed display speed is improved.

In the above-described control device, it may be configured such that a value indicating whether or not the change pixel is in the middle of the write operation is stored in a storage area for each of the change pixels, the value stored in the storage area is decreased or increased every time a plurality of frames, which is predetermined, elapses, and, in a case where the value stored in the storage area is a predetermined value, the write operation for the change pixel corresponding to the storage area ends, and, in a case where the value stored in the storage area is not the predetermined value, the write operation for the change pixel corresponding to the storage area is continued.

In such a case, since the access to the storage area is not performed for every one frame, a frequent access to the storage area is not necessary so as to determine the end of the write operation.

In addition, in the above-described control device, the specifying unit may be configured to specify the change pixel every time a plurality of frames elapses.

In such a case, since the access to the image data or the provisional image data is not performed for each one frame, frequent accesses to the data are not necessary so as to specify a change pixel.

In addition, in the above-described control device, it may be configured such that the number of times of applying a first voltage that is applied for changing the gray scale of the change pixel to the high density side, the number of times of applying a second voltage that is applied for changing the gray scale of the change pixel to the low density side, and a flag that represents the voltage that is applied first out of the first voltage and the second voltage are stored in the storage area for each pixel, the first voltage is applied to the change pixel corresponding to the storage area in accordance with the number of times of applying of the first voltage that is stored in the storage area, and then the second voltage is applied to the change pixel corresponding to the storage area in accordance with the number of times of applying of the second voltage that is stored in the storage area in a case where the flag stored, in the storage area indicates that the first voltage is applied first, and the second voltage is applied to the change pixel corresponding to the storage area in accordance with the number of times of applying of the second voltage that is stored in the storage area, and then the first voltage is applied to the change pixel corresponding to the storage area in accordance with the number of times of applying of the first voltage that is stored in the storage area, in a case where the flag stored in the storage area indicates that the second voltage is applied first.

In such a case, in a case where the first voltage used for setting the pixel to the high density and the second voltage used for setting the pixel to the low density are applied during the write operation, the number of applications and the voltage to be applied first can be designated, whereby a halftone pixel can be formed.

In addition, in the above-described control device, it may be configured such that the number of times of applying a voltage applied for changing the gray scale of the change pixel is stored in the storage area for each change pixel, the change pixel is determined as the first pixel or the second pixel based on the provisional image data, a first voltage that is used for changing the gray scale of the change pixel to a high density side is applied to the change pixel in accordance with the number of times of applying the voltage that is stored in the storage area corresponding to the change pixel in a case where the change pixel is the first pixel, and a second voltage that is used for changing the gray scale of the change pixel to a low density side is applied to the change pixel in accordance with the number of times of applying the voltage that is stored in the storage area corresponding to the change pixel in a case where the change pixel is the second pixel.

In such a case, since the number of times of applying the voltage is stored in one storage area for each pixel, the storage area may be smaller than that in a case where a storage area in which the number of times of applying the first voltage is stored and a storage area in which the number of times of applying the second voltage is stored are arranged for each pixel.

According to another aspect of the invention, there is provided a control device for a display device in which each of a plurality of pixels is configured by a first electrode, a display element, and a second electrode by interposing the display element between a first substrate in which the first electrodes are disposed and a second substrate in which the second electrodes are disposed in correspondence with the plurality of pixels. A gray scale of the pixel is changed by a write operation in which a voltage is applied to the pixel a plurality of times, and, within one frame period, a voltage is applied to a first pixel, of which a gray scale is changed to a high density side, with the first electrode of the first pixel being set to one of positive polarity and negative polarity with respect to the second electrode, and a voltage is applied to a second pixel, of which a gray scale is changed to a low density side, with the first electrode of the second pixel being set to polarity opposite to the one of positive polarity and negative polarity with respect to the second electrode. The control device includes: a control unit that applies a voltage to the pixel based on a table in which a voltage to be applied for each of the plurality of times in the write operation is determined; a specifying unit that specifies change pixels, of which gray scales are changed, among the plurality of pixels by comparing image data written into a memory and provisional image data representing a provisional image to be displayed on the display device by the write operation that is in the middle of the process; and an update unit that starts the write operation for the change pixel so as to have a gray scale determined based on the image data in a case where the change pixel is not in the middle of the process of the write operation, and, after completion of the write operation that is in the middle of the process, starts the write operation for the change pixel so as to have a gray scale determined based on the image data in a case where the change pixel is in the middle of the process of the write operation.

According to this control device, the write operation is immediately started for a pixel, of which the gray scale is to be changed, that is not in the middle of the write operation, and whereby a sensed display speed is improved.

In addition, in the above-described control device using a table, it may be configured such that the pixels are arranged in a plurality of rows and a plurality of columns, a value that indicates whether or not the pixels in a row are in the middle of the write operation is stored in a storage area for each row, the value stored in the storage area is decreased or increased every time one frame elapses, and the write operation for the change pixel in a row corresponding to the storage area ends in a case where the value stored in the storage area is a predetermined value, and the write operation for the change pixel in the row corresponding to the storage area is continued in a case where the value stored in the storage area is not the predetermined value.

In such a case, since the storage area indicating whether a write operation is in the middle of the process is configured as one storage area for one row, the storage area may be smaller than that of a configuration in which the storage area is arranged for each pixel.

In addition, in the above-described control device using a table, it may be configured such that the pixels are arranged in a plurality of rows and a plurality of columns, a value that indicates whether or not the pixels within a block are in the middle of the write operation is stored in a storage area for each block acquired by dividing the pixels into a plurality of blocks, the value stored in the storage area is decreased or increased every time one frame elapses, and the write operation for the change pixel in a row corresponding to the storage area ends in a case where the value stored in the storage area is a predetermined value, and the write operation for the change pixel in the row corresponding to the storage area is continued in a case where the value stored in the storage area is not the predetermined value.

In such a case, since the storage area indicating whether a write operation is in the middle of the process is configured as one storage area for one block, the storage area may be smaller than that of a configuration in which the storage area is arranged for each pixel.

In addition, in the above-described control device, in the pixel for which the write operation ends, an electric potential of the first electrode may be controlled to be the same as that of the second electrode after the end of the write operation.

In such a case, when the write operation ends, there is no electric potential difference between the pixel electrode of the pixel and the transparent electrode. Accordingly, an excessive voltage is not applied to the pixel, and the degradation of the display element can be suppressed.

In addition, in the above-described control device, in a case where the write operation is not performed for all the plurality of pixels, supply of power to a circuit that applies a voltage to the pixels may be configured to be blocked.

In such a case, since the supply of power to the circuit that applies a voltage to the pixels is blocked when the write operation for the pixels is not performed, the power consumption of the display device can be suppressed.

According to still another aspect of the invention, there is provided a display device in which each of a plurality of pixels is configured by a first electrode, a display element, and a second electrode by interposing the display element between a first substrate in which the first electrodes are disposed and a second substrate in which the second electrodes are disposed in correspondence with the plurality of pixels. A gray scale of the pixel is changed by a write operation in which a voltage is applied to the pixel a plurality of times, and, within one frame period, a voltage is applied to a first pixel, of which a gray scale is changed to a high density side, with the first electrode of the first pixel being set to one of positive polarity and negative polarity with respect to the second electrode, and a voltage is applied to a second pixel, of which a gray scale is changed to a low density side, with the first electrode of the second pixel being set to polarity opposite to the one of positive polarity and negative polarity with respect to the second electrode. The display device includes: a specifying unit that specifies change pixels, of which gray scales are changed, among the plurality of pixels by comparing image data written into a memory and provisional image data representing a provisional image to be displayed on the display device by the write operation that is in the middle of the process; and an update unit that starts the write operation for the change pixel so as to have a gray scale determined based on the image data in a case where the change pixel is not in the middle of the process of the write operation, and, after completion of the write operation that is in the middle of the process, starts the write operation for the change pixel so as to have a gray scale determined based on the image data in a case where the change pixel is in the middle of the process of the write operation.

According to this display device, the write operation is immediately started for a pixel, of which the gray scale is to be changed, that is not in the middle of the write operation, and whereby a sensed display speed is improved.

According to yet another aspect of the invention, there is provided a display device in which each of a plurality of pixels is configured by a first electrode, a display element, and a second electrode by interposing the display element between a first substrate in which the first electrodes are disposed and a second substrate in which the second electrodes are disposed in correspondence with the plurality of pixels. A gray scale of the pixel is changed by a write operation in which a voltage is applied to the pixel a plurality of times, and, within one frame period, a voltage is applied to a first pixel, of which a gray scale is changed to a high density side, with the first electrode of the first pixel being set to one of positive polarity and negative polarity with respect to the second electrode, and a voltage is applied to a second pixel, of which a gray scale is changed to a low density side, with the first electrode of the second pixel being set to polarity opposite to the one of positive polarity and negative polarity with respect to the second electrode. The display device includes: a control unit that applies a voltage to the pixel based on a table in which a voltage to be applied for each of the plurality of times in the write operation is determined; a specifying unit that specifies change pixels, of which gray scales are changed, among the plurality of pixels by comparing image data written into a memory and provisional image data representing a provisional image to be displayed on the display device by the write operation that is in the middle of the process; and an update unit that starts the write operation for the change pixel so as to have a gray scale determined based on the image data in a case where the change pixel is not in the middle of the process of the write operation, and, after completion of the write operation that is in the middle of the process, starts the write operation for the change pixel so as to have a gray scale determined based on the image data in a case where the change pixel is in the middle of the process of the write operation.

According to this display device, the write operation is immediately started for a pixel, of which the gray scale is to be changed, that is not in the middle of the write operation, and whereby a sensed display speed is improved.

According to still yet another aspect of the invention, there is provided a method of controlling a display device in which each of a plurality of pixels is configured by a first electrode, a display element, and a second electrode by interposing the display element between a first substrate in which the first electrodes are disposed and a second substrate in which the second electrodes are disposed in correspondence with the plurality of pixels. A gray scale of the pixel is changed by a write operation in which a voltage is applied to the pixel a plurality of times, and, within one frame period, a voltage is applied to a first pixel, of which a gray scale is changed to a high density side, with the first electrode of the first pixel being set to one of positive polarity and negative polarity with respect to the second electrode, and a voltage is applied to a second pixel, of which a gray scale is changed to a low density side, with the first electrode of the second pixel being set to polarity opposite to the one of positive polarity and negative polarity with respect to the second electrode. The method includes: specifying change pixels, of which gray scales are changed, among the plurality of pixels by comparing image data written into a memory and provisional image data representing a provisional image to be displayed on the display device by the write operation that is in the middle of the process; and starting the write operation for the change pixel so as to have a gray scale determined based on the image data in a case where the change pixel is not in the middle of the process of the write operation, and, after completion of the write operation that is in the middle of the process, starting the write operation for the change pixel so as to have a gray scale determined based on the image data in a case where the change pixel is in the middle of the process of the write operation.

According to this control method, the write operation is immediately started for a pixel, of which the gray scale is to be changed, that is not in the middle of the write operation, and whereby a sensed display speed is improved.

According to further another aspect of the invention, there is provided a method of controlling a display device in which each of a plurality of pixels is configured by a first electrode, a display element, and a second electrode by interposing the display element between a first substrate in which the first electrodes are disposed and a second substrate in which the second electrodes are disposed in correspondence with the plurality of pixels. A gray scale of the pixel is changed by a write operation in which a voltage is applied to the pixel a plurality of times, and, within one frame period, a voltage is applied to a first pixel, of which a gray scale is changed to a high density side, with the first electrode of the first pixel being set to one of positive polarity and negative polarity with respect to the second electrode, and a voltage is applied to a second pixel, of which a gray scale is changed to a low density side, with the first electrode of the second pixel being set to polarity opposite to the one of positive polarity and negative polarity with respect to the second electrode. The method includes: applying a voltage to the pixel based on a table in which a voltage to be applied for each of the plurality of times in the write operation is determined; specifying change pixels, of which gray scales are changed, among the plurality of pixels by comparing image data written into a memory and provisional image data representing a provisional image to be displayed on the display device by the write operation that is in the middle of the process; and starting the write operation for the change pixel so as to have a gray scale determined based on the image data in a case where the change pixel is not in the middle of the process of the write operation, and, after completion of the write operation that is in the middle of the process, starting the write operation for the change pixel so as to have a gray scale determined based on the image data in a case where the change pixel is in the middle of the process of the write operation.

According to this control method, the write operation is immediately started for a pixel, of which the gray scale is to be changed, that is not in the middle of the write operation, and whereby a sensed display speed is improved.

### BRIEF DESCRIPTION OF THE DRAWINGS

The invention will be described with reference to the accompanying drawings, wherein like numbers reference like elements.

FIG. 1 is a block diagram showing the hardware configuration of a display device.

FIG. 2 is a diagram showing a cross-section of a display unit.

FIG. 3 is a diagram illustrating the circuit configuration of the display unit.

FIG. 4 is a diagram illustrating the configuration of a pixel driving circuit included in the display unit.

FIG. 5 is a block diagram showing the functional configuration realized by a controller.

FIG. 6 is a flowchart showing the flow of the process performed by the controller.

FIG. 7 is a diagram illustrating an operation of the display device.

FIG. 8 is a diagram illustrating an operation of the display device.

FIG. 9 is a diagram illustrating an operation of the display device.

FIG. 10 is a diagram illustrating an operation of the display device.

FIG. 11 is a diagram illustrating an operation of the display device.

FIG. 12 is a diagram illustrating an operation of the display device.

FIG. 13 is a diagram illustrating an operation of the display device.

FIG. 14 is a diagram illustrating an operation of the display device.

FIG. 15 is a diagram illustrating an operation of the display device.

FIG. 16 is a diagram illustrating an operation of the display device.

FIG. 17 is a diagram illustrating an operation of the display device.

FIG. 18 is a diagram illustrating an operation of the display device.

FIG. 19 is a diagram illustrating an operation of the display device.

FIG. 20 is a diagram illustrating an operation of the display device.

FIG. 21 is a diagram illustrating an operation of the display device.

FIG. 22 is a diagram illustrating an operation of the display device.

FIG. 23 is a block diagram showing the hardware configuration of a display device.

FIG. 24 is a diagram showing the contents of Tables according to a second embodiment.

FIG. 25 is a flowchart showing the flow of the process performed by a controller according to the second embodiment.

FIG. 26 is a diagram illustrating the operation of the display device.

FIG. 27 is a diagram illustrating the operation of the display device.

FIG. 28 is a diagram illustrating the operation of the display device.

FIG. 29 is a diagram illustrating the operation of the display device.

FIG. 30 is a diagram illustrating the operation of the display device.

FIG. 31 is a diagram illustrating the operation of the display device.

FIG. 32 is a diagram illustrating the operation of the display device.

FIGS. 33A and 33B are diagrams showing applications of a display device according to an embodiment of the invention.

FIG. 34 is a flowchart showing the flow of the process performed by a controller according to a modified example.

FIG. 35 is a diagram illustrating the operation of a display device according to a modified example.

FIG. 36 is a diagram illustrating the operation of a display device according to another modified example.

FIG. 37 is a flowchart showing the flow of the process performed by a controller according to a modified example.

FIG. 38 is a diagram illustrating the operation of a display device according to the modified example.

FIG. 39 is a flowchart showing the flow of the process performed by a controller according to another modified example.

FIG. 40 is a diagram illustrating the operation of a display device according to the modified example.

FIG. 41 is a flowchart showing the flow of a process performed by a controller according to yet another modified example.

FIG. 42 is a diagram illustrating the operation of a display device according to the modified example.

### DESCRIPTION OF EXEMPLARY EMBODIMENTS

### First Embodiment

### Configuration of Display Device 100

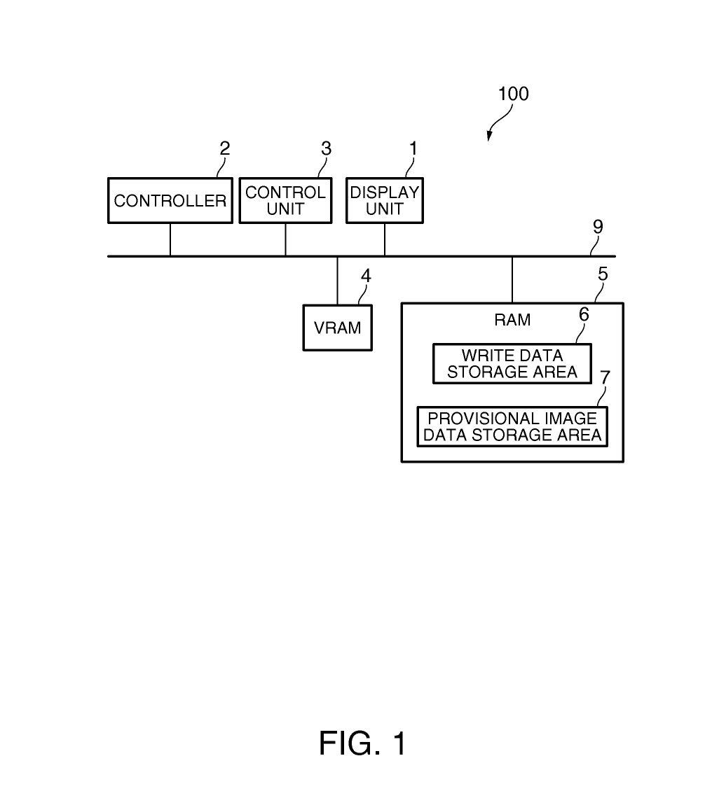

FIG. 1 is a block diagram showing the hardware configuration of a display device 100 according to an embodiment of the invention. The display device 100 is an electrophoretic display device and includes a display unit 1, a controller 2, a control unit 3, a VRAM (Video RAM) 4, and a RAM (Random Access Memory) 5. The units of the display device 100 are interconnected through a bus 9.

The display unit 1 has a memory-type display device and is a display in which a displayed image is maintained even when a voltage is not applied to the display device. In this embodiment, the display unit 1 has a display device that includes electrophoretic particles and displays a monochrome image. The controller 2 drives the display unit 1 and outputs various signals used for displaying an image on the display unit 1. The control unit 3 is a microcomputer that includes a CPU (Central Processing Unit), a ROM (Read Only Memory), a RAM, and the like and controls each unit of the display device 100. In addition, the control unit 3 writes various types of data into the VRAM 4 by accessing the VRAM 4. The VRAM 4 is a memory that stores image data representing an image to be displayed on the display unit 1. The RAM 5 is a memory that stores data used for displaying an image on the display unit 1, and a write data storage area 6 and a provisional image data storage area 7 are arranged therein. The controller 2 corresponds to a control device for the display device 100. In addition, a combination of the controller 2 and the control unit 3 may be defined as a control device for the display device 100. Alternatively, all of the controller 2, the control unit 3, the VRAM 4, and the RAM 5 may be collectively defined as a control device for the display device 100.

### Configuration of Display Unit 1

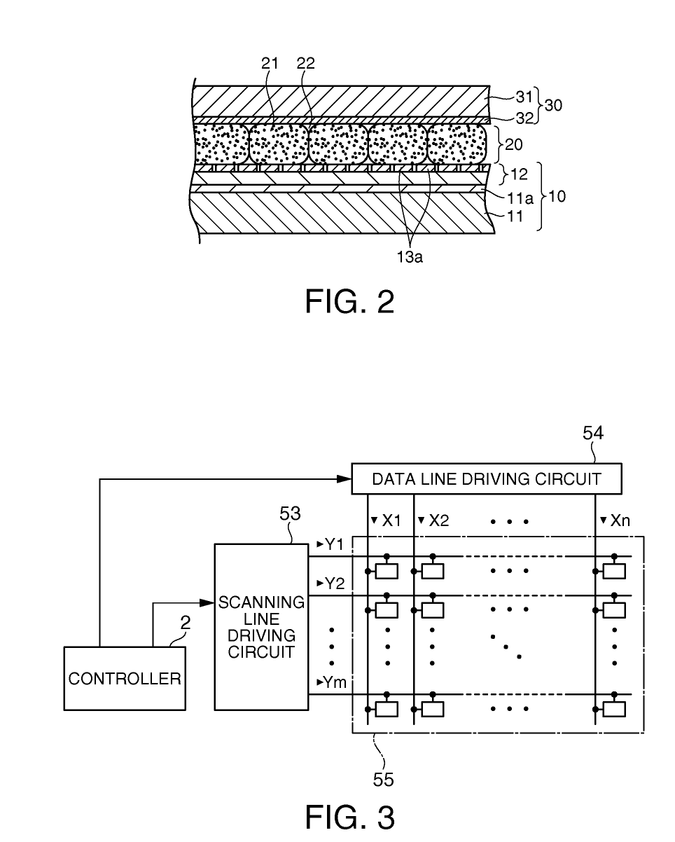

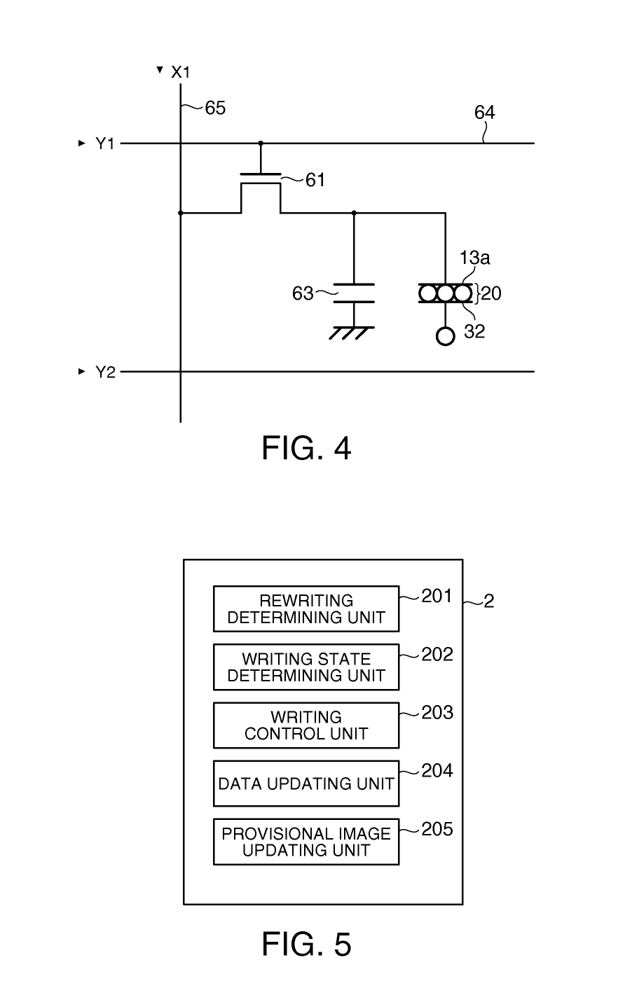

FIG. 2 is a diagram showing the cross-section of the display unit 1. In addition, FIG. 3 is a diagram illustrating the circuit configuration of the display unit 1, and FIG. 4 is a diagram illustrating the configuration of a pixel driving circuit included in the display unit 1. The display unit 1, as shown in FIG. 2, is mainly configured by a first substrate 10, an electrophoretic layer 20, and a second substrate 30. The first substrate 10 is a substrate acquired by forming a circuit layer on a substrate 11 having an insulating property and flexibility. The substrate 11 is formed from polycarbonate in this embodiment. The material of the substrate 11 is not limited to polycarbonate, and a resin material having lightness, flexibility, elasticity, and an insulating property can be used. Furthermore, the substrate 11 may be formed from glass that does not have flexibility. On the surface of the substrate 11, an adhesive layer 11a is disposed. In addition, on the surface of the adhesive layer 11a, a circuit layer 12 is laminated.

The circuit layer 12 has a plurality of scanning lines 64 arranged in the horizontal direction and a plurality of data lines 65 that are disposed so as to maintain electrical insulation from each scanning line and are arranged in the vertical direction. In addition, the circuit layer 12 has a pixel driving circuit that is configured by a pixel electrode 13a (first electrode) and a TFT (Thin Film Transistor) in correspondence with each intersection of the scanning lines 64 and the data lines 65.

The electrophoretic layer 20 is configured by a binder 22 and a plurality of microcapsules 21 fixed by the binder 22 and is formed on the pixel electrode 13a. In addition, between the microcapsule 21 and the pixel electrode 13a, an adhesive layer formed by an adhesive may be disposed.

The material of the binder 22 is not particularly limited as long as it has good affinity with the microcapsule 21, superior adhesiveness for the electrodes, and an insulating property. Inside the microcapsule 21, a dispersion medium and electrophoretic particles are stored. As a material composing the microcapsule 21, a compound having flexibility such as gum arabic, a gelatin-based compound, or a urethane-based compound is preferably used.

Examples of the dispersion medium include: water; an alcohol-based solvent such as methanol, ethanol, isopropanol, butanol, octanol, or methyl cellosolve; ester such as ethyl acetate or butyl acetate; ketone such as acetone, methyl ethyl ketone, or methyl isobutyl ketone; aliphatic hydrocarbon such as pentane, hexane, or octane; alicyclic hydrocarbon such as cyclohexane or methyl cyclohexane; aromatic hydrocarbon such as benzene, toluene, benzene having a long-chain alkyl group such as xylene, hexyl benzene, heptyl benzene, octyl benzene, nonyl benzene, decyl benzene, undecyl benzene, dodecyl benzene, tridecyl benzene, or tetradecyl benzene; halogenated hydrocarbon such as methylene chloride, chloroform, carbon tetrachloride, or 1,2-dichloroethane; and carboxylic salt. In addition, the dispersion medium may be other kinds of oil. One or more of them may be used independently or in combination. Furthermore, a dispersion medium in which a surfactant is further mixed may be used.

The electrophoretic particle is a particle (a high molecule or a colloid) having a characteristic such that it moves in the dispersion medium in accordance with an electric field. In this embodiment, white electrophoretic particles and black electrophoretic particles are stored inside the microcapsule 21. The black electrophoretic particles are particles formed from black pigment such as aniline black or carbon black and are positively charged in this embodiment. The white electrophoretic particles are particles formed from white pigment such as titanium dioxide or aluminum oxide and are negatively charged in this embodiment.

The second substrate 30 is configured by a film 31 and a transparent electrode layer 32 (second electrode) formed on the lower face of the film 31. The film 31 is responsible for sealing and protecting the electrophoretic layer 20 and, for example, is a polyethylene terephthalate film. The film is transparent and has an insulating property. The transparent electrode layer 32 is configured by a transparent conductive film such as an indium tin oxide film (ITO film).

Next, circuits included in the display unit 1 will be described. The controller 2 outputs a signal used for displaying an image in a display region 55 or various signals used for driving the display unit 1. In the display region 55 shown in FIG. 3, a plurality of data lines 65 arranged parallel to one another in the vertical direction and a plurality of scanning lines 64 arranged parallel to one another in the horizontal direction are disposed. In addition, in the display region 55, pixel driving circuits are disposed in correspondence with intersections of the data lines 65 and the scanning lines 64.

FIG. 4 is a diagram illustrating the configuration of each pixel driving circuit. In this embodiment, in order to identify each scanning line 64, the scanning lines shown in FIG. 3 may be sequentially referred to as first, second, third, . . . , (m−1)-th, and m-th scanning lines from the upper side. Similarly, in order to identify the data lines 65, the data lines shown in FIG. 3 may be sequentially referred to as first, second, third, . . . , (n−1)-th, and n-th data lines from the left side.

FIG. 4 shows a pixel driving circuit corresponding to an intersection of the first scanning line 64 and the first data line 65. The same pixel driving circuit is disposed at an intersection of another data line 65 and another scanning line 64. However, since the configuration of each pixel driving circuit is the same, here, the pixel driving circuit corresponding to the intersection of the first data line and the first scanning line will be representatively described, and the description of the other pixel driving circuits will be omitted.

In the pixel driving circuit, the gate of a transistor 61 is connected to the scanning line 64, and the source of the transistor 61 is connected to the data line. In addition, the drain of the transistor 61 is connected to the pixel electrode 13a. The pixel electrode 13a faces the transparent electrode layer 32, and the electrophoretic layer 20 is interposed between the pixel electrode 13a and the transparent electrode layer 32. The microcapsule 21 interposed between one pixel electrode 13a and the transparent electrode layer 32 forms one pixel of the display unit 1. In addition, in the pixel driving circuit, a storage capacitor 63 is connected in parallel with the electrophoretic layer 20. The electric potential of the transparent electrode layer 32 is set to an electric potential Vcom set in advance.

The scanning line driving circuit 53 is connected to the scanning lines 64 located in the display region 55 and supplies scanning signals Y1, Y2, . . . , Ym to the first, second, . . . , m-th scanning lines 64. To be more specific, the scanning line driving circuit 53 selects the scanning lines 64 in the order of the first, second, . . . , m-th scanning lines. The scanning line driving circuit 53 sets the voltage of the scanning signal of the selected scanning line 64 to a selection voltage V_{H} (H level) and sets the voltage of the scanning signal of the scanning lines that are not selected to a non-selection voltage V_{L} (L level).

The data line driving circuit 54 is connected to the data lines located in the display region and supplies data signals X1, X2, . . . , Xn to the first, second, . . . , n-th data lines 65. A data signal is supplied from the data line 65 to the pixel driving circuit that is connected to the scanning line 64 of which the electric potential is the selection voltage V_{H}. To be more specific, when the scanning line 64 is at the H level, the transistor 61 of which the gate is connected to the scanning line 64 is in the On state, and thus, the pixel electrode 13a is connected to the data line 65. Accordingly, when a data signal is supplied to the data line 65 when the scanning line 64 is at the H level, the data signal is applied to the pixel electrode 13a through the transistor 61 that is in the On state. When the scanning line 64 is at the L level, the transistor 61 is in the Off state. However, the voltage applied to the pixel electrode 13a in accordance with the data signal is accumulated in the storage capacitor 63, and accordingly, the electrophoretic particles move in accordance with an electric potential difference (voltage) between the electric potential of the pixel electrode 13a and the electric potential of the transparent electrode layer 32.

For example, in a case where the electric potential of the pixel electrode 13a with respect to the electric potential Vcom of the transparent electrode layer 32 is +15V, the white electrophoretic particles that are negatively charged move to the pixel electrode 13a side, and the black electrophoretic particles that are positively charged move to the transparent electrode layer 32 side, whereby the pixel displays black. On the other hand, in a case where the electric potential of the pixel electrode 13a with respect to the electric potential Vcom of the transparent electrode layer 32 is −15V, the black electrophoretic particles that are positively charged move to the pixel electrode 13a side, and the white electrophoretic particles that are negatively charged move to the transparent electrode layer 32 side, whereby the pixel displays white.

In the description presented hereinafter, a period until selection of the Y-th scanning line is completed after the scanning line driving circuit 53 selects the first scanning line is referred to as a “frame period” or simply a “frame”. Each scanning line 64 is selected once for one frame, and a data signal is supplied to each pixel driving circuit once for one frame.

In addition, in this embodiment, in order to change the display state of each pixel from white (low density) to black (high density) or from black to white, the display state is changed not by driving the pixel driving circuit only for one frame, but the display state is changed by a write operation of applying a voltage to a pixel over a plurality of frames. The reason for this is that even in a case where an electric potential difference is given to the electrophoretic particles only for one frame when the display state is to be changed from white to black, the black electrophoretic particles do not completely move to the display side, and accordingly, the display state is not a completely black state. This similarly applies to the white electrophoretic particles in a case where the display state is changed from black to white. Accordingly, for example, in a case where the display state of the pixel is changed from white to black, a data signal used for displaying black at the pixel is supplied to the pixel driving circuit over a plurality of frames. On the other hand, in a case where the display state of the pixel is changed from black to white, a data signal used for displaying white at the pixel is supplied over a plurality of frames.

In addition, in this embodiment, within one frame, the pixel electrode 13a of a pixel can be set to a positive polarity in which the electric potential is higher than that of the transparent electrode layer 32, and, within the same frame, the pixel electrode 13a of another pixel can be set to a negative polarity in which the electric potential is lower than that of the transparent electrode layer 32. In other words, within one frame, both polarities including the positive polarity and the negative polarity can be selected for the transparent electrode layer 32 in the driving (hereinafter, referred to as bipolar driving). Described in more detail, within one frame, the pixel electrode 13a of the pixel of which the gray scale is changed to the high density side is set to the positive polarity, and the pixel electrode 13a of the pixel of which the gray scale is changed to the low density side is set to the negative polarity. In addition, in a case where the black electrophoretic particles are negatively charged, and the white electrophoretic particles are positively charged, it may be configured such that the pixel electrode 13a of the pixel of which the gray scale is changed to the high density side is set to the negative polarity, and the pixel electrode 13a of the pixel of which the gray scale is changed to the low density side is set to the positive polarity.

### Configuration of Controller 2

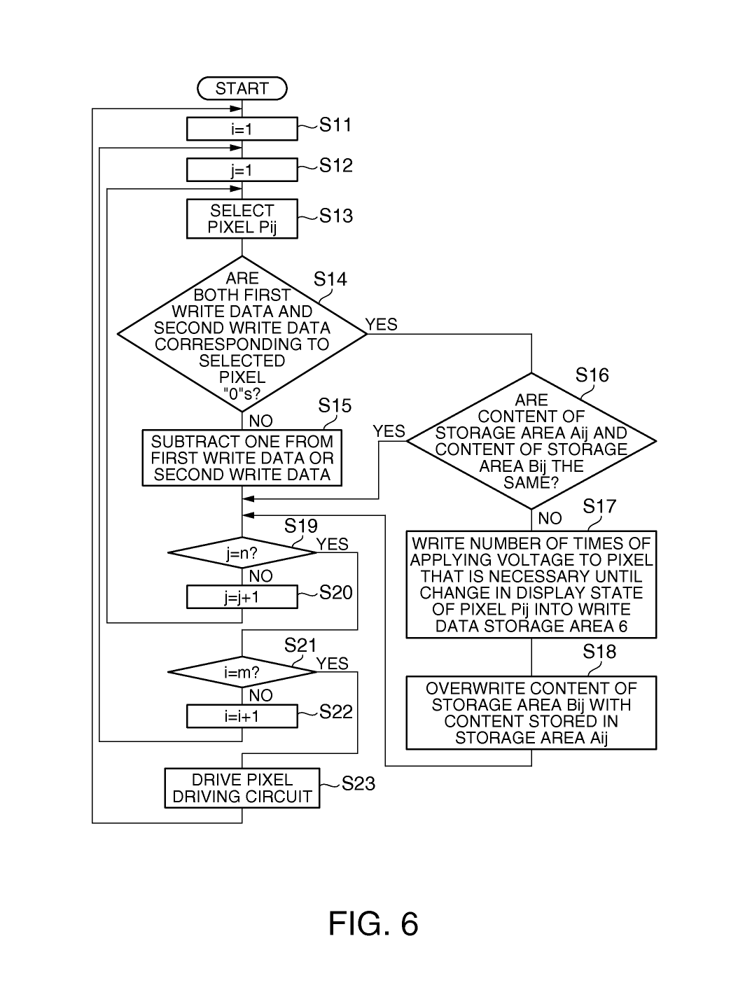

Next, the configuration of the controller 2 will be described. FIG. 5 is a block diagram showing the functions realized by the controller 2. In the controller 2, a rewriting determining unit 201, a writing state determining unit 202, a writing control unit 203, a data updating unit 204, and a provisional image updating unit 205 are implemented. Each of these blocks may be realized by hardware, or each block may be realized by arranging a CPU in the controller 2 and executing a program by using the CPU.

The rewriting determining unit 201 is a block that determines whether the image data stored in the VRAM 4 and the image data stored in the provisional image data storage area 7 are different from each other by comparing them. The writing state determining unit 202 is a block that determines whether a rewriting operation for changing the pixel from black to white or from white to black is in the middle of the process by referring to data that is stored in the write data storage area 6. In addition, in the write data storage area 6, a white write data storage area 6A in which data (first write data) indicating whether or not an operation of changing the display state from black to white for each pixel is in the middle of the process and a black write data storage area 6B in which data (second write data) indicating whether or not an operation of changing the display state from white to black for each pixel is in the middle of the process are arranged.

The writing control unit 203 is a block that controls the scanning line driving circuit 53 and the data line driving circuit 54 such that data signals are supplied to the pixel electrodes 13a. The data updating unit 204 is a block that writes data into the white write data storage area 6A and the black write data storage area 6B. The provisional image updating unit 205 is a block that overwrites the image data stored in the provisional image data storage area 7 with the image data stored in the VRAM 4.

### Operation According to Embodiment

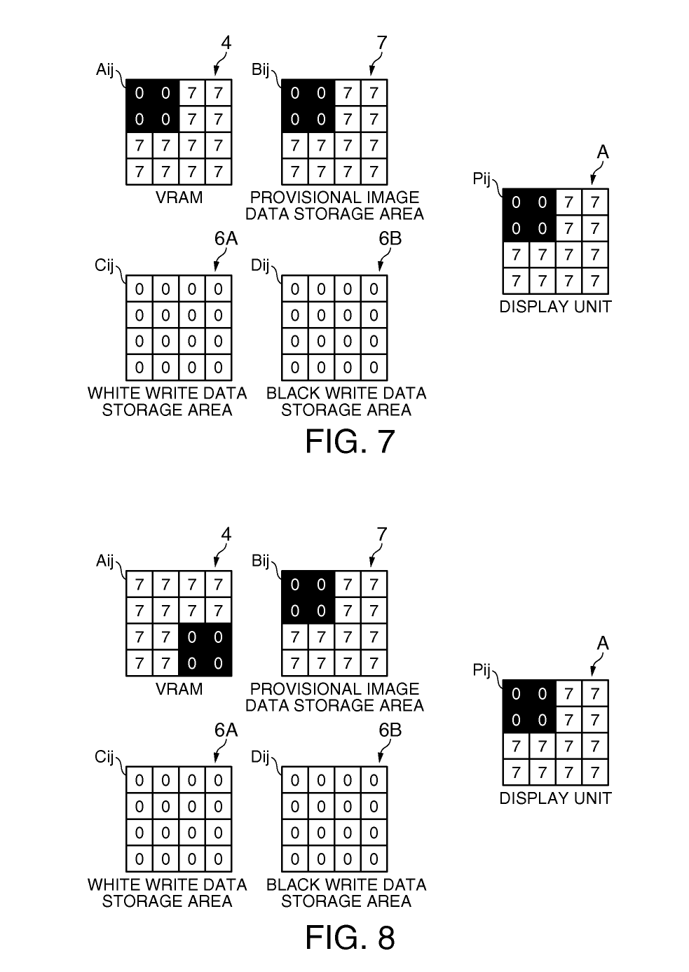

Next, the operation of the display device 100 will be described with reference to FIGS. 6 to 22. In FIGS. 7 to 22, an image A denotes an image that is displayed on the display unit 1. In addition, a pixel Pij denotes one pixel. Here, in subscript, i denotes the row number of a pixel arranged in a matrix, and j denotes a column number of the pixel. Hereinafter, in a case where a pixel is specified in the description, for example, a pixel of the first row and the first column is referred to as a pixel P11. In addition, although gray scales of eight levels from black to white are denoted by numbers between 0 to 7 for easy understanding of the gray scale of each pixel in the image A, actually the numbers are not displayed. Furthermore, although pixels are present at the intersections of m scanning lines 64 and n data lines 65 in the display unit 1, in order to prevent the complexity of the drawings, pixels P11 to P44 of four rows and four columns located in a part of the display unit 1 are illustrated in FIGS. 7 to 22.

In addition, in FIGS. 7 to 22, the content of a storage area Aij corresponding to pixels P11 to P44 in the VRAM 4, the content of a storage area Bij corresponding to pixels P11 to P44 in the provisional image data storage area 7, the content of a storage area Cij corresponding to pixels P11 to P44 in the white write data storage area 6A, and the content of a storage area Dij corresponding to pixels P11 to P44 in the black write data storage area 6B are shown. In addition, for each storage area, in subscript, i denotes the row number of the storage area disposed in the matrix, and j denotes the column number. For example, in a case where a storage area is specified in the description, for example, a storage area Aij of the first row and the first column is referred to as a storage area A11.

The gray scales of pixels of an image displayed on the display unit 1 are stored in the storage areas A11 to A44 of the VRAM 4, and the gray scales of pixels of a provisional image to be displayed on the display unit 1 are stored in the storage areas B11 to B44 of the provisional image data storage area 7. The number of times of applying a voltage that is necessary for displaying white in each of the pixels P11 to P44 is stored as first write data in each of the storage areas C11 to C44 of the white write data storage area 6A, and the number of times of applying a voltage that is necessary for displaying black in each of the pixels P11 to P44 is stored as second write data in the storage areas D11 to D44 of the black write data storage area 6B. The first write data or the second write data indicates that a rewriting operation for a pixel is in the middle of the process in a case where the data is not “0”, and indicates that the rewriting operation for a pixel is completed in a case where the data is “0”.

When driving the pixels, the controller 2 performs the process shown in FIG. 6. First, the writing state determining unit 202 initializes the values of variables i and j to “1” (Steps S11 and S12). Next, the writing state determining unit 202 selects a pixel Pij that is specified by the variables i and j (Step S13). For example, in a case where the value of the variable i is “1”, and the value of the variable j is “1”, the pixel P11 is selected.

Next, the writing state determining unit 202 determines whether or not both the first write data stored in the storage area Cij corresponding to the selected pixel Pij and the second write data stored in the storage area Dij are respectively “0” (Step S14). In a case where both the first write data of the storage area Cij and the second write data of the storage area Dij corresponding to the selected pixel Pij are “0” (Yes in Step S14), the writing state determining unit 202 proceeds to Step S16. On the other hand, in a case where either the first write data or the second write data is other than “0” (No in Step S14), the writing state determining unit 202 proceeds to Step S15. When the process proceeds to Step S15, the data updating unit 204 subtracts “1” from the data, which is other than “0”, of the first write data stored in the storage area Cij and the second write data stored in the storage area Dij. On the other hand, the data updating unit 204 does not subtract “1” from the first write data or the second write data that has a value “0”.

On the other hand, when the process proceeds to Step S16, the rewriting determining unit 201 compares the data stored in the storage area Aij and the data stored in the storage area Bij with each other. Here, in a case where the data stored in the storage area Aij and the data stored in the storage area Bij are different from each other (No in Step S16), the rewriting determining unit 201 specifies the pixel Pij as a pixel of which the display state is newly changed (specifying process), and a data updating process is performed in which data relating to the specified pixel Pij is updated.

In the data updating process, the data updating unit 204 writes the number times of applying a voltage to the pixel that is necessary for changing the gray scale of the pixel Pij to the gray scale of the storage area Aij in the write data storage area 6 (Step S17). In addition, the provisional image updating unit 205 overwrites the content of the storage area Bij with the content stored in the storage area Aij (Step S18).

Next, the controller 2 determines whether or not the value of the variable j is the number n of the data lines in Step S19. Here, in a case where the variable j is not the same as n (No in Step S19), one is added to the value of the variable j (Step S20), and the process proceeds to Step S13. On the other hand, in a case where the value of the variable j is n, it is determined whether or not the value of the variable i is the same as the number m of scanning lines. Here, in a case where the value of the variable i is not m (No in Step S21), one is added to the value of the variable i (Step S22), and the process proceeds to Step S12. On the other hand, in a case where the value of the variable i is m (Yes in Step S21), the writing control unit 203 drives the pixel driving circuit by controlling the scanning line driving circuit 53 and the data line driving circuit 54 (Step S23).

Next, a change in the display, a change in the content of the VRAM 4, a change in the content of the provisional image data storage area 7, and the change in the content of the write data storage area 6 in the display unit 1 until an image of image data is displayed on the display unit 1 after the image data is written into the VRAM 4 will be described with reference to FIGS. 7 and 22.

In a case where the state of the display of the display unit 1, the VRAM 4, the write data storage area 6, and the provisional image data storage area 7 are the state shown in FIG. 7, when the control unit 3 writes image data into the VRAM 4 (data writing process), the state of the VRAM 4 is in the state shown in FIG. 8 in accordance with the image data.

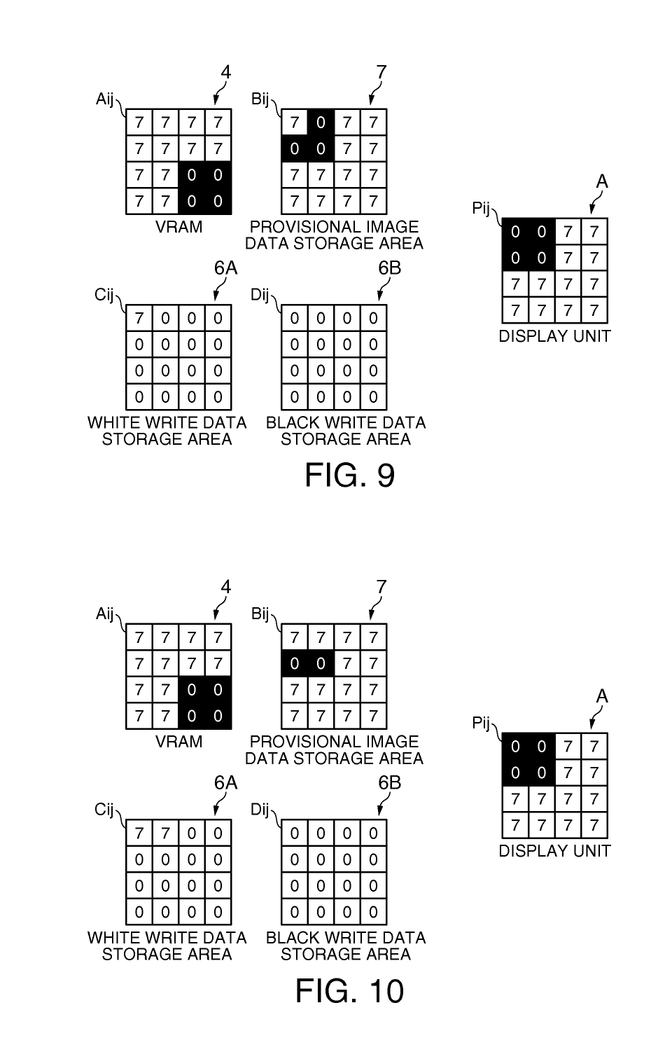

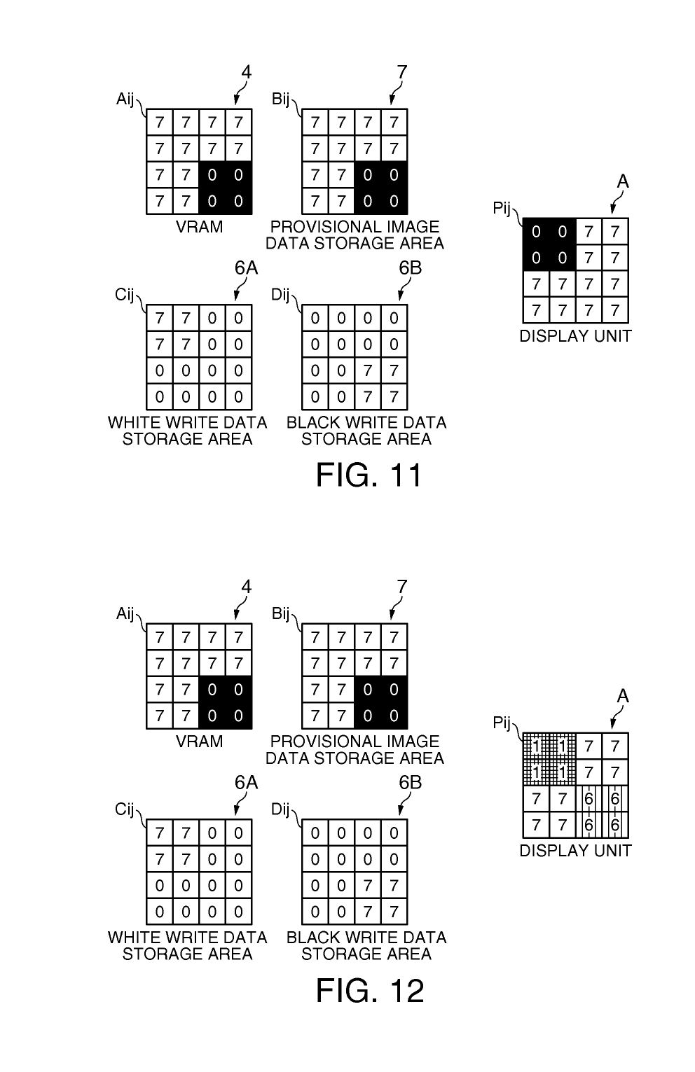

When the pixel P11 is selected in Step S13 in the state shown in FIG. 8, “Yes” is determined in Step S14, and “No” is determined in Step S16. Since the content of the storage area B11 represents black, and the content of the storage area A11 represents white, the pixel P11 is changed from black to white. Accordingly, “7” is written in the storage area C11 in Step S17, and the content of the storage area A11 is written into the storage area B11 in Step S18, whereby the state shown in FIG. 9 is formed. Next, when the pixel P12 is selected, “Yes” is determined in Step S14, and “No” is determined in Step S16. Accordingly, “7” is written into the storage area C12 in Step S17, and the content of the storage area A12 is written into the storage area B12 in Step S18, whereby the state shown in FIG. 10 is formed. In addition, when the pixel P33 is selected, “Yes” is determined in Step S14, and “No” is determined in Step S16. Since the content of the storage area B33 represents white, and the content of the storage area A33 represents black, the pixel P33 is changed from white to black. Accordingly, “7” is written in the storage area D33 in Step S17, and the content of the storage area A11 is written into the storage area B11 in Step S18. Thereafter, when the selection is made up to the pixel P44, as shown in FIG. 11, the content of the provisional image data storage area 7 is the same as that of the VRAM 4. In addition, a state is formed in which “7” is written into the storage areas C11, C12, C21, and C22 of the white write data storage area 6A, and “7” is written into the storage areas D33, D34, D43, and D44 of the black write data storage area 6B.

Thereafter, when the process of Step S23 is performed, in the pixel driving circuit (the pixel driving circuit corresponding to an intersection of the first scanning line 64 and the first data line 65) corresponding to the pixel P11, the content of the storage area C11 is other than “0”, and accordingly, when the scanning line 64 is selected, a voltage is applied to the data line 65 such that the electric potential of the pixel electrode 13a is −15 V with respect to the electric potential Vcom of the transparent electrode layer 32. In addition, also in the pixel driving circuits corresponding to the pixels P12, P21, and P22, the contents of the storage areas C12, C21, and C22 are other than “0”. Accordingly, when the scanning line 64 is selected, a voltage is applied to the data line 65 such that the electric potential of the pixel electrode 13a is −15 V with respect to the electric potential Vcom of the transparent electrode layer 32.

In addition, in the pixel driving circuit (the pixel driving circuit corresponding to the intersection of the third scanning line 64 and the third data line 65) corresponding to the pixel P33, the content of the storage area D33 is other than “0”. Accordingly, when the scanning line 64 is selected, a voltage is applied to the data line 65 such that the electric potential of the pixel electrode 13a is +15 V with respect to the electric potential Vcom of the transparent electrode layer 32. Furthermore, in the pixel driving circuits corresponding to the pixels P34, P43, and P44, the contents of the storage areas D34, D43, and D44 are other than “0”. Accordingly, when the scanning line 64 is selected, a voltage is applied to the data line 65 such that the electric potential of the pixel electrode 13a is +15 V with respect to the electric potential Vcom of the transparent electrode layer 32.

Furthermore, for other pixels, the content of the corresponding storage area in the white write data storing unit 6A is “0”, and the content of the corresponding storage area in the black write data storage area 6B is “0”. Accordingly, a voltage is applied to the data line 65 such that a difference between the electric potential of the pixel electrode 13a and the electric potential Vcom of the transparent electrode layer 32 is 0 V when the scanning line 64 is selected. When the voltage is applied to the data line 65 as above, the white particles and the black particles of the pixel move, and the display of the display unit 1 is in the state shown in FIG. 12.

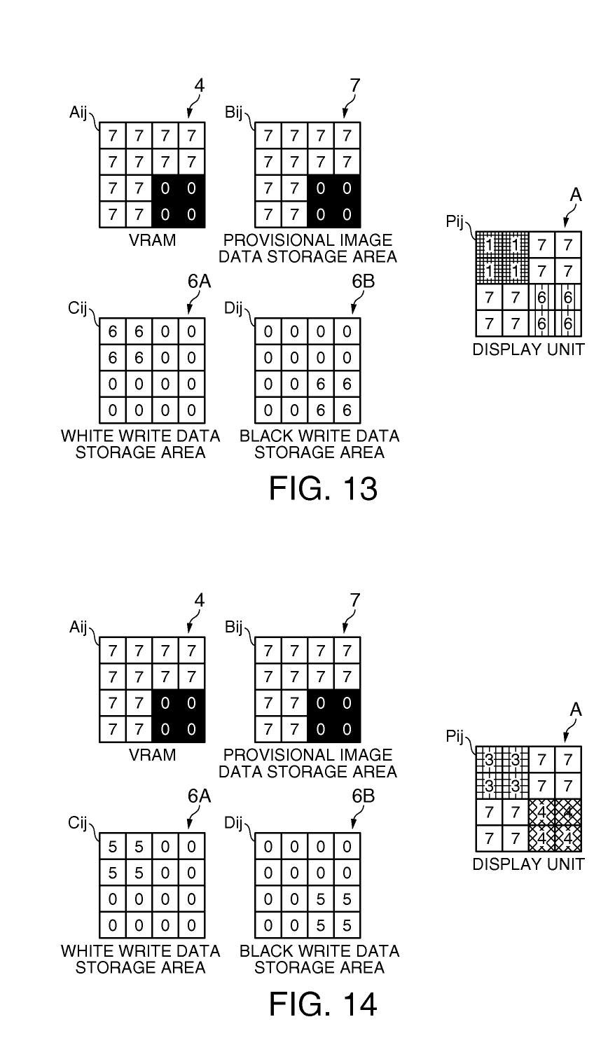

When the process of Step S23 is completed, the controller 2 returns the flow of the process to Step S11. When the pixel P11 is selected in Step S13 in the state shown in FIG. 12, “No” is determined in Step S14, “1” is subtracted from the value written into the storage area C11, and the content of the storage area C11 is “6”. Next, when the pixel P12 is selected, “No” is determined in Step S14, “1” is subtracted from the value written into the storage area C12, and the content of the storage area C12 is “6”. Thereafter, when selection is made up to the pixel P44, as shown in FIG. 13, the contents of the storage areas C11, C12, C21, and C22 are “6”, and the contents of the storage areas D33, D34, D43, and D44 are respectively “6”.

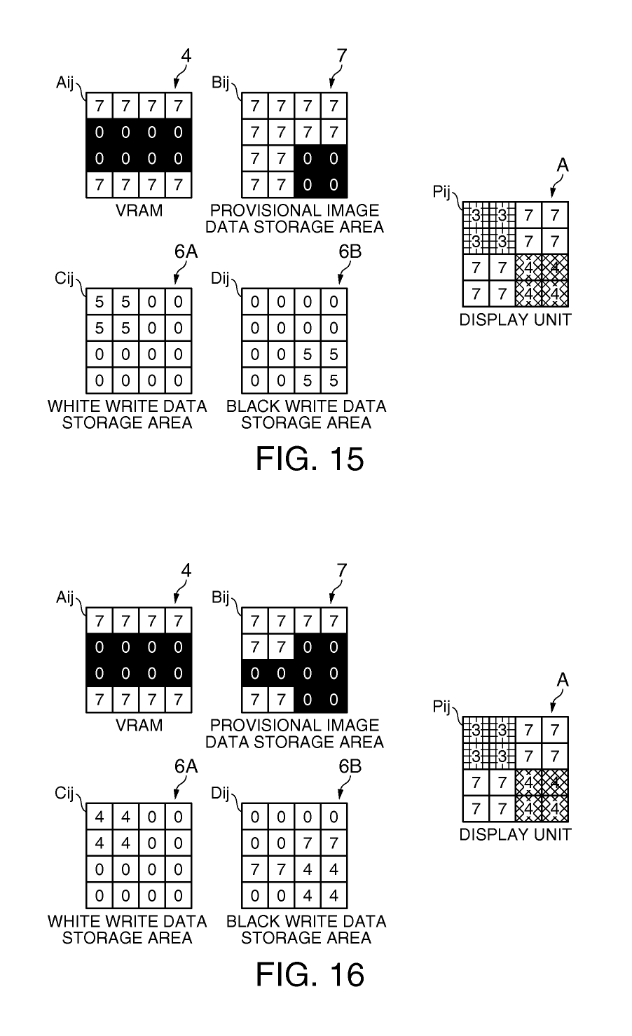

FIG. 14 is a diagram showing the state immediately after performing the process of Step S23 for the second time in the state shown in FIG. 13. Here, as shown in FIG. 15, a case will be described in which the content of the VRAM 4 is rewritten. When the pixel P21 is selected in Step S13 in the state shown in FIG. 15, “No” is determined in Step S14. Accordingly, “1” is subtracted from a value written into the storage area C21 in Step S15, and the content of the storage area C21 is “4”. On the other hand, when the pixel P23 is selected in Step S13, “Yes” is determined in Step S14, and “No” is determined in Step S16. Accordingly, “7” is written into the storage area D23 in Step S17, and the content of the storage area A23 is written into the storage area B23 in Step S18. As above, even when the content of the VRAM 4 is rewritten from white to black, rewriting the content for white progresses for a pixel for which rewriting for white is in the middle of the process, and the second write data is stored in the black write data storage area 6B for a pixel for which rewriting is not performed. In addition, when the pixel P43 is selected in Step S13 in the state shown in FIG. 15, “No” is determined in Step S14, and “1” is subtracted from the value written into the storage area D43 in Step S15, whereby the content of the storage area D43 is “4”. As above, even when the content of the VRAM 4 is rewritten from black to white, rewriting progresses for the pixel for which rewriting for black is in the middle of the process.

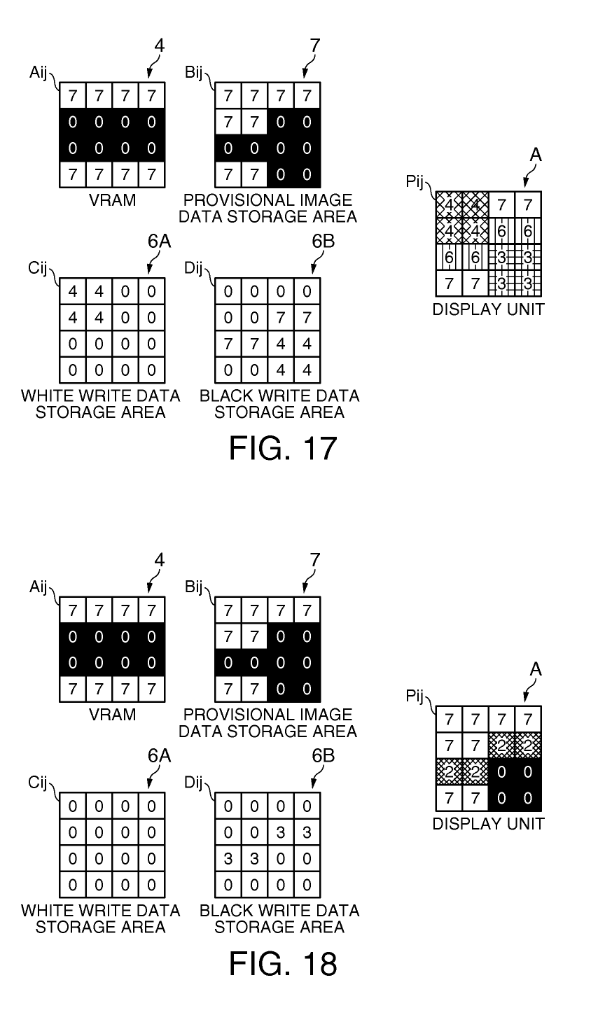

When the process is performed until “Yes” is determined in Step S21 from the state shown in FIG. 15, the state of the VRAM 4 and the storage areas is as shown in FIG. 16. In addition, when the process of Step S23 is performed in the state shown in FIG. 16, the state of the display unit 1 is the state shown in FIG. 17. Accordingly, for the pixels corresponding to a portion for which the content of the VRAM 4 is rewritten, rewriting that is in the middle of the process progresses for the pixel for which rewriting currently progresses, and new rewriting of the pixel is started for which rewriting is not performed.

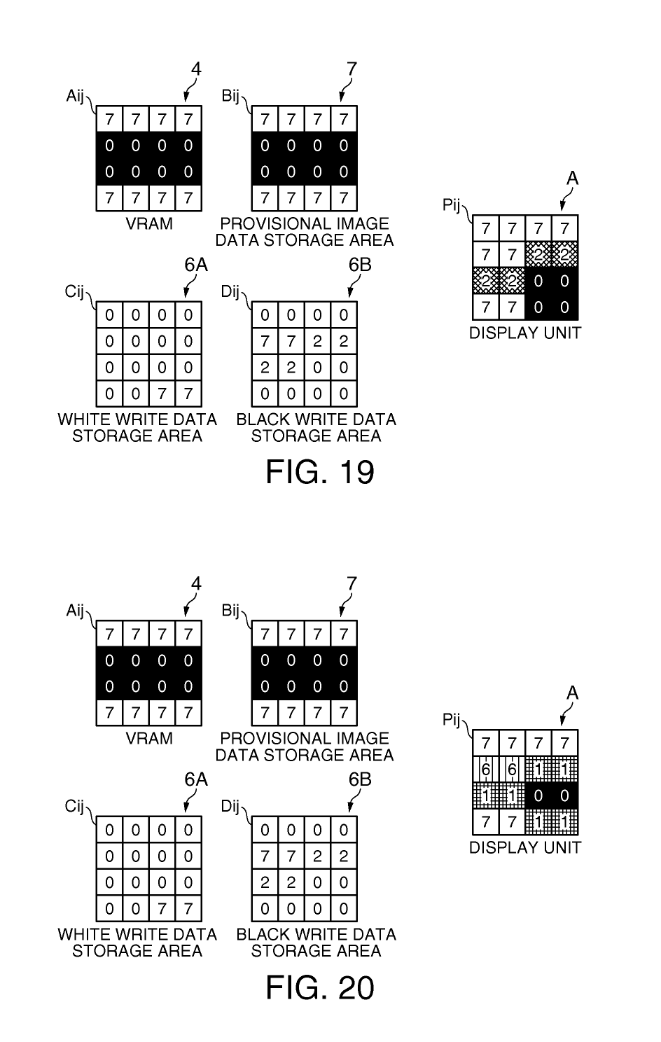

When the process progresses further, and the values of the first write data and the second write data are respectively “0” for the pixel for which rewriting has been started first, the displays of the storage areas and the display unit 1 are in the states as shown in FIG. 18. Then, when a pixel P21 is selected in Step S13 in the state shown in FIG. 18, “Yes” is determined in Step S14, and “No” is determined in Step S16. Accordingly, “7” is written in the storage area D21 in Step S17, and the content of the storage area A21 is written into the storage area B21 in Step S18. In addition, when a pixel P41 is selected in Step S13, “Yes” is determined in Step S14, and “No” is determined in Step S16. Accordingly, “7” is written into the storage area C41 in Step S17, and the content of the storage area A41 is written into the storage area B41 in Step S18. Thereafter, when the process is performed until “Yes” is determined in Step S21, the contents of the storage areas are in the state shown in FIG. 19. Thus, when the process of Step S23 is performed, a state shown in FIG. 20 is formed.

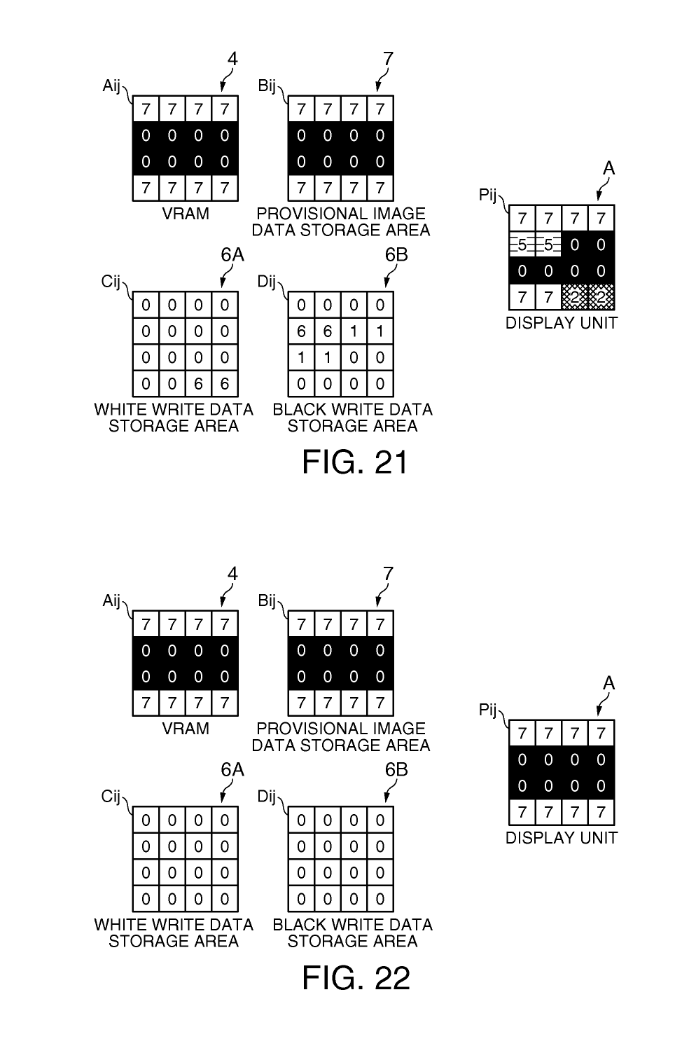

Thereafter, when the process progresses, and the process of Step S23 is performed in the state shown in FIG. 21, the state of the display unit 1 is as shown in FIG. 21, and the rewriting for the pixels P23, P24, P31, and P32 is completed. In addition, when the process further progresses, rewriting for the pixels P21, P22, P43, and P44 progresses, and finally, a state shown in FIG. 22 is formed.

According to this embodiment, even in a case where an area for which rewriting is started first and an area for which rewriting is newly started overlap each other, when rewriting is newly started, rewriting is immediately started for a portion for which rewiring is not in the middle of the process. Therefore, the display speed experienced by the user is high.

### Second Embodiment

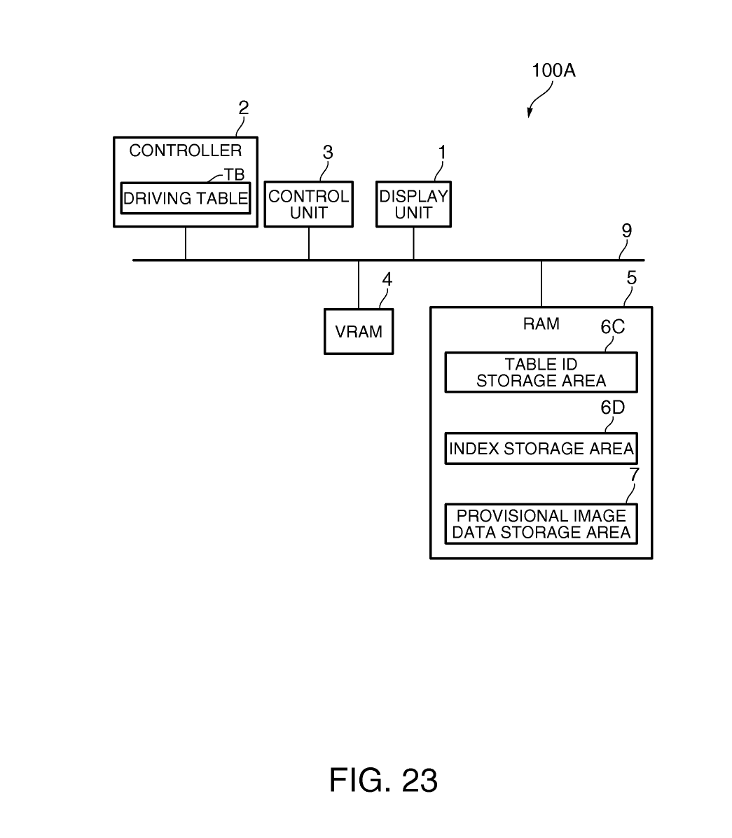

Next, a display device 100A according to a second embodiment of the invention will be described. FIG. 23 is a diagram showing the hardware configuration of the display device 100A. In the description presented below, the same reference numeral is assigned to the same configuration as that of the display device 100 according to the first embodiment, and the description thereof will be omitted. The operation of the display device 100A at the time of changing the gray scale of the pixel is different from that of the first embodiment. The controller 2 has a driving table TB. In addition, in the RAM 5, a table ID storage area 6C and an index storage area 6D are arranged.

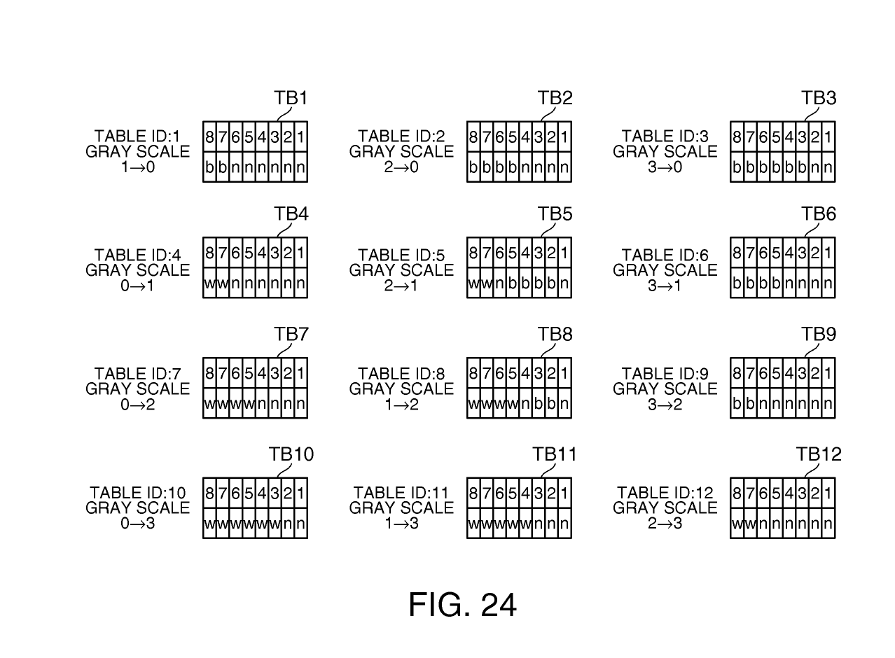

FIG. 24 is a diagram showing the content of the driving table TB. The driving table TB is configured by twelve tables TB1 to TB12 that are identified by table IDs. In this embodiment, the pixel takes gray scales of four levels from black to white, and the gray scales are sequentially denoted by numbers from “0” (black) to “3” (white). The tables TB1 to TB12 are selected when the gray scale of a pixel is changed from the current gray scale to another gray scale, and the table to be selected can be determined based on the gray scale of the pixel before change, and the gray scale thereof after change.

In order to change the gray scale of the pixel, a voltage is applied to the pixel electrode 13a over a plurality of times, and data representing a voltage applied to the pixel electrode 13a at each time when the gray scale of the pixel is changed from the current gray scale to another gray scale is stored in each table. Numbers 1 to 8 stored in the table are indices. Here, data “b”, “w”, or “n” associated with each index represents a voltage applied to the pixel electrode 13a at each time. Here, “b” represents applying a positive voltage having an electric potential difference of +15 V with respect to the electric potential of the transparent electrode layer 32, and “w” represents applying a negative voltage having an electric potential difference of −15 V with respect to the electric potential of the transparent electrode layer 32. In addition, “n” represents a state in which an electric potential difference between the pixel electrode 13a and the transparent electrode layer 32 is zero.

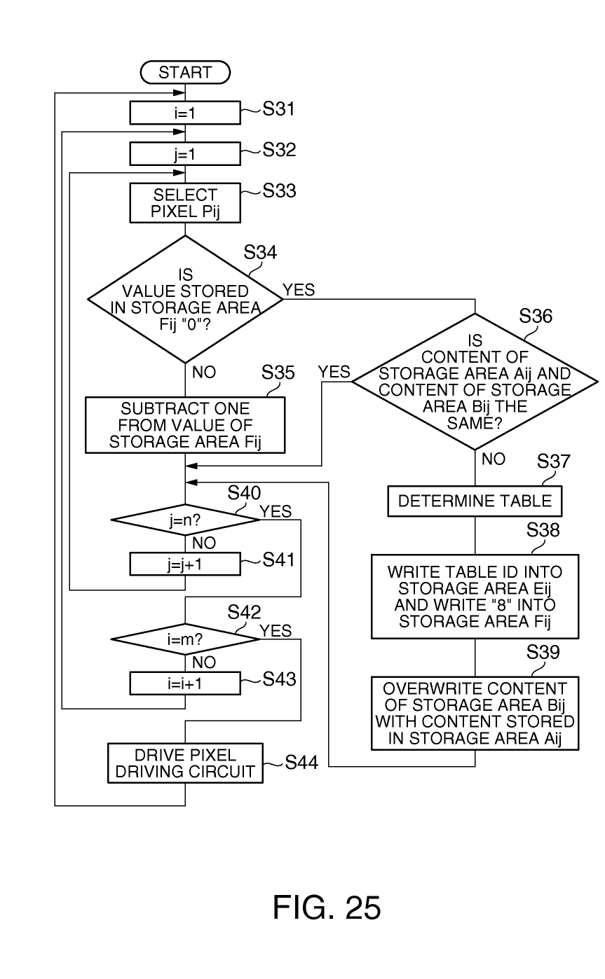

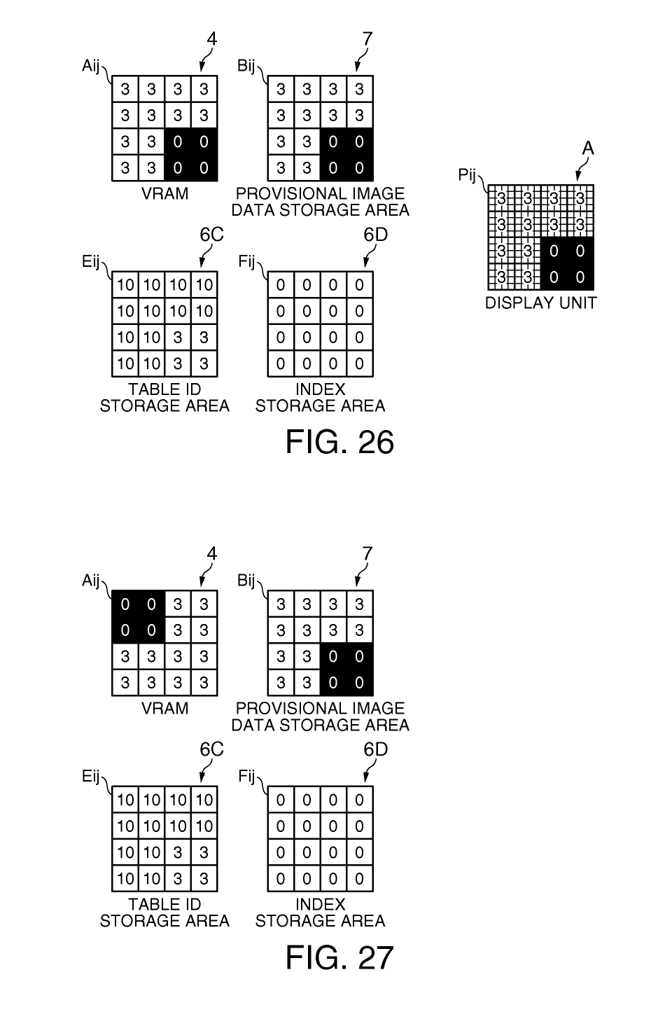

Next, the flow of the process performed by the display device 100A and the operation of the display device 100A will be described with reference to FIGS. 25 to 32. In addition, in FIGS. 26 to 32, in addition to the contents of the VRAM 4 and the provisional image data storage area 7, the content of a storage area Eij corresponding to each of pixels P11 to P44 in the table ID storage area 6C and the content of a storage area Fij corresponding to each of the pixels P11 to P44 in the index storage area 6D are shown. In storage areas E11 to E44, a table ID of a table that is used when the gray scale of the pixel is changed is stored. For example, in a case where “1” is stored as a table ID, the table TB1 of which the table ID is “1” is used when the gray scale of a pixel is changed. In addition, in storage areas F11 to F44, numbers that indicate indexes of the table that are referred to are stored.

When driving pixels, the controller 2 performs the process shown in FIG. 25. First, the process of Steps S31 to S33 is the same as the process of Steps S11 to S13 of the first embodiment. Next, the writing state determining unit 202 determines whether the value of the index stored in the storage area Fij corresponding to the selected pixel Pij is “0” (Step S34). Here, in a case where the content of the storage area Fij is “0” (Yes in Step S34), the writing state determining unit 202 proceeds to Step S36. On the other hand, in a case where the content of the storage area Fij is other than “0” (No in Step S34), the writing state determining unit 202 proceeds to Step S35. When the process proceeds to Step S35, the data updating unit 204 subtract one from the value of the storage area Fij.

When the process proceeds to Step S36, the rewriting determining unit 201 compares data stores in the storage area Aij and data stored in the storage area Bij with each other. Here, in a case where there is a difference thereof (No in Step S36), the rewriting determining unit 201 determines a table out of the tables TB1 to TB12 that is used for changing the gray scale of the pixel from the gray scale stored in the storage area Bij to the gray scale stored in the storage area Aij (Step S37). Next, an update process for updating data is performed, and the table ID of the table determined in Step S37 is written into the storage area Eij, and “8” is written into the storage area Fij (Step S38). In addition, the provisional image updating unit 205 overwrites the content of the storage area Bij with the content stored in the storage area Aij (Step S39).

The following process of Step S40 to Step S43 is the same as that of Step S19 to Step S22 of the first embodiment. In Step S44, the writing control unit 203 drives the pixel driving circuit by controlling the scanning line driving circuit 53 and the data line driving circuit 54.

Next, an example of the operation for driving a pixel will be described with reference to FIGS. 26 to 32. In the description presented below, a state is assumed in which image data is written into the storage area Aij as shown in FIG. 27 when the state of the VRAM 4 and the storage areas is the state shown in FIG. 26.

When the process shown in FIG. 25 is performed in the state shown in FIG. 27, and a pixel P11 is selected in Step S33, “Yes” is determined in Step S34, and “No” is determined in Step S36. Next in Step S37, since the content of the storage area B11 is “3”, and the content of the storage area A11 is “0”, the table TB3 representing to change the gray scale “3” to “0” is determined as the table used for changing the gray scale of the pixel P11. Next, the table ID of the table determined in Step S37 is written into the storage area E11, “8” is written into the storage area F11 (Step S38), and the content of the storage area B11 is overwritten with the content of the storage area A11 (Step S39).

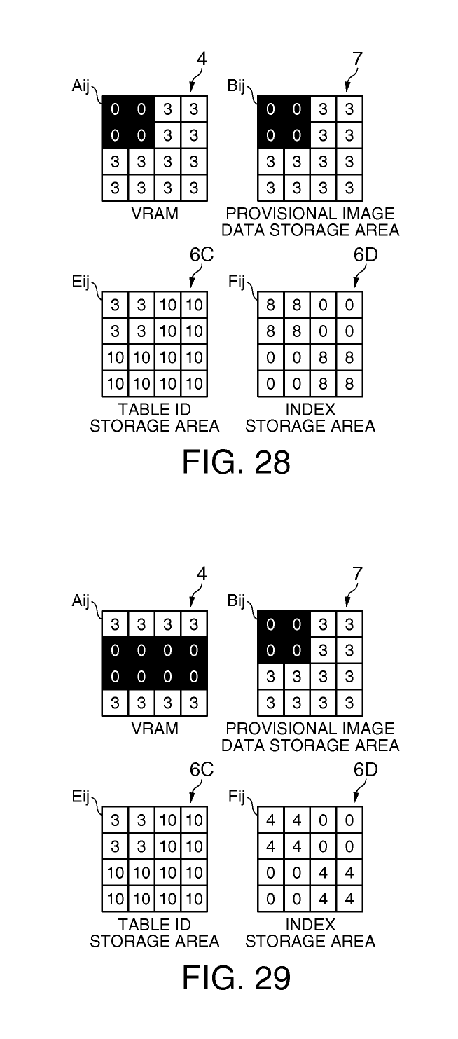

In addition, when a pixel P33 is selected in Step S33, “Yes” is determined in Step S34, and “No” is determined in Step S36. Next in Step S37, since the content of the storage area B33 is “0”, and the content of the storage area A33 is “3”, the table TB10 representing to change the gray scale “0” to “3” is determined as the table used for changing the gray scale of the pixel P33. Next, the table ID of the table determined in Step S37 is written into the storage area E33, “8” is written into the storage area F33 (Step S38), and the content of the storage area B33 is overwritten with the content of the storage area A33 (Step S39). At a time point when the process progresses, and “Yes” is determined in Step S42, the contents of the storage areas are in the state shown in FIG. 28.

Next, the process of Step S44 is performed. Here, the table ID stored in the storage area E11 for the pixel P11 is “3”, and the index stored in the storage area F11 is “8”. Since the data associated with the index “8” in Table TB3 for the pixel P11 is “b”, the pixel driving circuit is driven such that the electric potential of the pixel electrode 13a is +15 V with respect to the transparent electrode layer 32. In addition, the table ID stored in the storage area E33 for the pixel P33 is “10”, and the index stored in the storage area F11 is “8”. Since the data associated with the index “8” in Table TB10 for the pixel P33 is “w”, the pixel driving circuit is driven such that the electric potential of the pixel electrode 13a is −15 V with respect to the transparent electrode layer 32.

Here, a case will be considered in which the value of the index is, for example, the content of the VRAM 4 is rewritten as shown in FIG. 29 when the process shown in FIG. 25 is repeated, and the value of the index, for example, is “4” due to subtraction. When the pixel P11 for which the content of the VRAM 4 is rewritten is selected in Step S33 in the state shown in FIG. 29, “No” is determined in Step S34, and one is subtracted from the value written into the storage area F11 in Step S35, whereby the content of the storage area E11 is “3”. In addition, when the pixel P23 is selected in Step S33, “Yes” is determined in Step S34, and “No” is determined in Step S36. Thereafter, the table TB3 is determined in Step S37. Next, the table ID “3” of the table determined in Step S37 is written into the storage area E23, “8” is written into the storage area F23 (Step S38), and the content of the storage area B23 is overwritten with the content of the storage area A23 (Step S39).

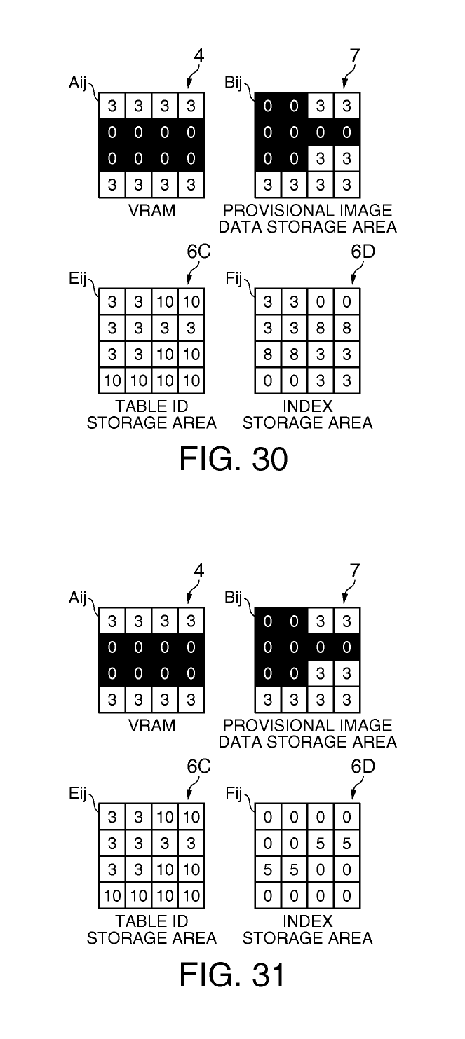

Then, when the process progresses until “Yes” is determined in Step S42, the contents of the storage areas are in the state shown in FIG. 30. As above, even when the content of the VRAM 4 is rewritten, rewriting in the middle of the process progresses for the pixel for which rewriting is in the middle of the process, and data is written for the pixel for which rewriting is not performed into the corresponding storage areas Eij and Fij, and rewriting for the pixel is newly started.

When the process further progresses from the state shown in FIG. 30, the content of the storage area Fij corresponding to the pixel for which rewriting is started first is “0”, and the contents of the storage areas are in the state shown in FIG. 31. When the pixel P11 is selected in Step S33 in the state shown in FIG. 30, “Yes” is determined in Step S34, and “No” is determined in Step S36. Thereafter, the table TB10 is determined in Step S37. Next, the table ID “10” of the table determined in Step S37 is written into the storage area E11, “8” is written into the storage area F11 (Step S38), and the content of the storage area B11 is overwritten with the content of the storage area A11 (Step S39). In addition, when the pixel P31 is selected in Step S33, “Yes” is determined in Step S34, and “No” is determined in Step S36. Thereafter, the table TB3 is determined in Step S37. Next, the table ID “3” of the table determined in Step S37 is written into the storage area E33, “8” is written into the storage area F33 (Step S38), and the content of the storage area B33 is overwritten with the content of the storage area A33 (Step S39).

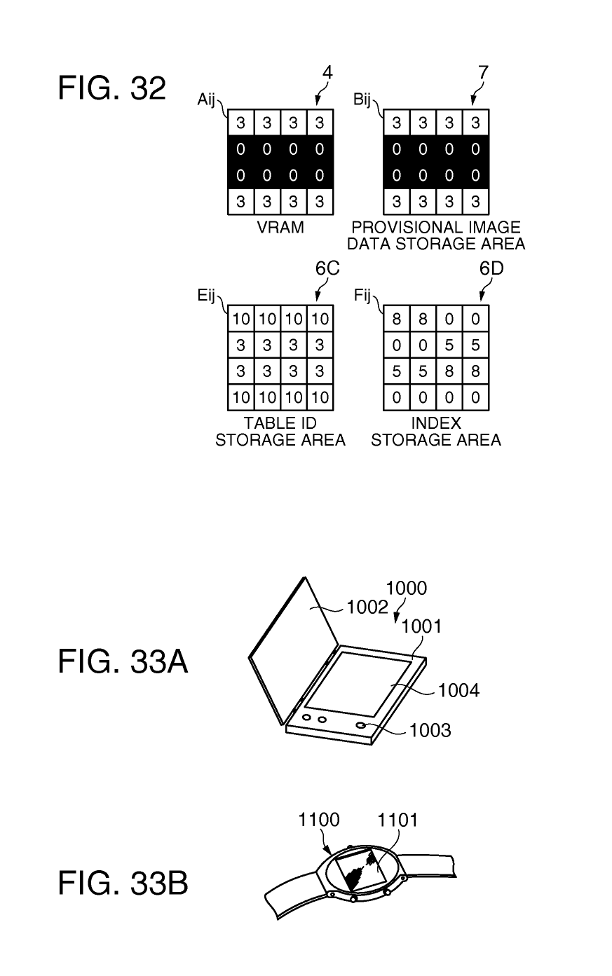

Then, when the process progresses until “Yes” is determined in Step S42, the contents of the storage areas are in the state shown in FIG. 32. Here, since the rewriting for the pixel is in the middle of the process, indices are newly written into the index storage area 6D for the pixels P11, P12, P33, and P34 for which pixel rewriting is not started, and rewriting for the pixel is started.

Also in this embodiment, even in a case where an area for which writing is started first and an area for which rewiring is newly started overlap each other, when rewriting is newly started, rewriting is immediately started for a portion for which rewiring is not in the middle of the process. Therefore, the display speed experienced by the user is high.

### Electronic Apparatuses

Next, electronic apparatuses using a display device according to the above-described embodiment will be described.

FIG. 33A is a perspective view of an electronic book reader using a display device according to the above-described embodiment. This electronic book reader 1000 includes a book-shaped frame 1001, a cover 1002 that is disposed in the frame 1001 so as to be freely opened or closed, an operation unit 1003, and a display device 100 according to the embodiment of the invention. In this electronic book reader 1000, the content of an electronic book is displayed on the display device 100, and a page of the electronic book is flipped by operating the operation unit 1003.

FIG. 33B is a perspective view of a wrist watch 1100 using a display device according to the above-described embodiment. This wrist watch 1100 includes a display device 100 according to an embodiment of the invention. In this wrist watch 1100, time and year/month/date are displayed on the display device 100.

In addition, examples of the electronic apparatuses to which the display device 100 according to the above-described embodiment can be applied include an electronic paper sheet, an electronic organizer, a calculator, a cellular phone, and the like.

### MODIFIED EXAMPLES

As above, the embodiments of the invention have been described. However, the invention is not limited to the above-described embodiments and may be performed in other various forms. For example, the above-described embodiments may be modified as below so as to realize the invention. In addition, each of the above-described embodiments and each of the modified examples described below may be combined together.

### Modified Example 1

In the display device 100 according to the embodiment of the invention, the supply of power to the controller 2 may be controlled by the control unit 3. For example, by arranging a switch in a line used for supplying power from a power source to the controller 2 and controlling the switch using the control unit 3, the power source and the controller 2 are connected to or separated from each other, whereby the supply of power from the power source to the controller 2 or blocking the power is performed. In addition, in a case where all the areas of the white write data storage area 6A are all “0”s, and all the areas of the black write data storage area 6B are all “0”s, the control unit 3 may block the supply of power to the controller 2 by controlling the switch. In a case where all the contents of the white write data storage area 6A and the black write data storage area 6B are all “0”s, the controller 2 does not need to control the data line driving circuit 54 or the scanning line driving circuit 53. Accordingly, even when power is not supplied to the data line driving circuit 54 and the scanning line driving circuit 53 so as not to be driven, the power consumption can be suppressed without causing any problem.

In addition, a power saving mode is arranged in which the controller 2 supplies power to circuits that access the VRAM 4 or the RAM 5, and power is not supplied to circuits that control the scanning line driving circuit 53 or the data line driving circuit 54, and, in a case where all the areas of the white write data storage area 6A are all “0”s, and all the areas of the black write data storage area 6B are all “0”s, the controller 2 may transit to the power saving mode so as to suppress the power consumption. Furthermore, when a predetermined time elapses after all the areas of the white write data storage area 6A are “0”s, and all the areas of the black write data storage area 6B are all “0”s, the supply of power to the controller 2 may be blocked, or the process may proceed to the power saving mode.

In addition, also in the second embodiment, in a case where all the values of the indices are all “0”s, blocking the supply of power to the controller 2 or the transition to the power saving mode may be performed.

### Modified Example 2

In the above-described embodiment, although one is subtracted from the first write data stored into the white write data storage area 6A or the second write data stored in the black write data storage area 6B every time when one frame elapses, such a process may not be performed for everyone frame. For example, in the first embodiment, the transition to Step S11 may be made after the process of Step S23 is performed a plurality of times (for example, four times). According to such a configuration, the number of accesses to the VRAM 4 and the RAM 5 can be decreased. In addition, also in the second embodiment, the transition to Step S31 may be made after the process of Step S44 is performed a plurality of times (for example, four times).

### Modified Example 3

In the above-described embodiment, every time one frame elapses, in a case where “Yes” is determined in Step S14 for each pixel, it is determined whether or not the contents of the VRAM 4 and the provisional image data storage area are the same in Step S16. However, the process of Step S16 may not be performed every time one frame elapses. For example, it may be configured such that a flag is arranged of which the value changes as 1, 0, 1, 0, . . . every time one frame elapses, the process of Step S16 is performed in a case where the flag is “1”, and the process of Step S16 is not performed in a case where the flag is “0”. In addition, also in the second embodiment, it may be configured such that the process of Step S36 is performed in a case where the flag is “1”, and the process of Step S36 is not performed in a case where the flag is “0”.

### Modified Example 4

In the above-described embodiments, there are two storage areas including the white write data storage area 6A in which the first write data is stored and the black write data storage area 6B in which the second write data is stored. However, instead of the white write data storage area 6A and the black write data storage area 6B, it may be configured such that a black/white write data storage area 6E in which black/white write data indicating whether or not an operation of changing the display state of the pixel from black to white or from white to black is in the middle of the process is stored, and the black/white write data is stored in the storage area.

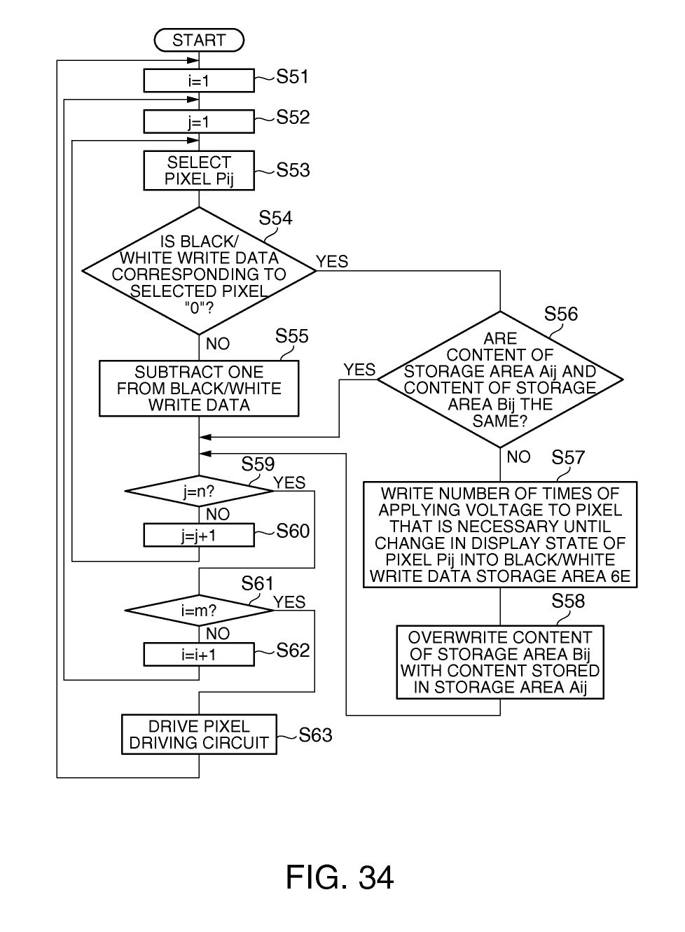

FIG. 34 is a flowchart showing the flow of the process performed by a controller 2 according to this modified example. FIG. 35 represents an image displayed on the display unit 1 and the contents of the VRAM 4, the provisional image data storage area 7, and the black/white write data storage area 6E. FIG. 35 shows the contents of the storage areas Aij corresponding to pixels P11 to P44 in the VRAM 4, the contents of the storage area Bij corresponding to the pixels P11 to P44 in the provisional image data storage area 7, and the contents of the storage areas Gij corresponding to the pixels P11 to P44 in the black/white data storage area 6E.

When driving the pixel, the controller 2 performs the process shown in FIG. 34. First, the process of Steps S51 to S53 is the same as the process of Steps S11 to S13 of the first embodiment. Next, in Step S54, the writing state determining unit 202 determines whether or not the black/white write data stored in the storage area Gij corresponding to a selected pixel Pij is “0” (Step S54). In a case where the black/white write data of the storage area Gij corresponding to the selected pixel Pij is “0” (Yes in Step S54), the writing state determining unit 202 proceeds to Step S56. On the other hand, in a case where the black/white write data is other than “0” (No in Step S54), the writing state determining unit 202 proceeds to Step S55. In Step S55, the data updating unit 204 subtract one from the value of the black/white write data stored in the storage area Gij.

On the other hand, in Step S56, the rewriting determining unit 201 compares data stored in the storage area Aij and data stored in the storage area Bij with each other. Here, in a case where there is a difference therebetween (No in Step S56), the rewriting determining unit 201 specifies the pixel Pij (specifying process) as a pixel of which the display state is newly changed, and a date updating process is performed in which the data relating to the specified pixel Pij is updated. In the data updating process, the data updating unit 204 writes the number of times of applying a voltage that is necessary for changing the gray scale of the pixel Pij to the gray scale of the storage area Aij in the black/white write data storage area 6E as the black/white write data (Step S57). In addition, the provisional image updating unit 205 overwrites the content of the storage area Bij with the content stored in the storage area Aij (Step S58). The next process of Steps S59 to S62 is the same process as the process of Steps S19 to S22 of the first embodiment. Then, the pixel driving circuit is driven in Step S63.

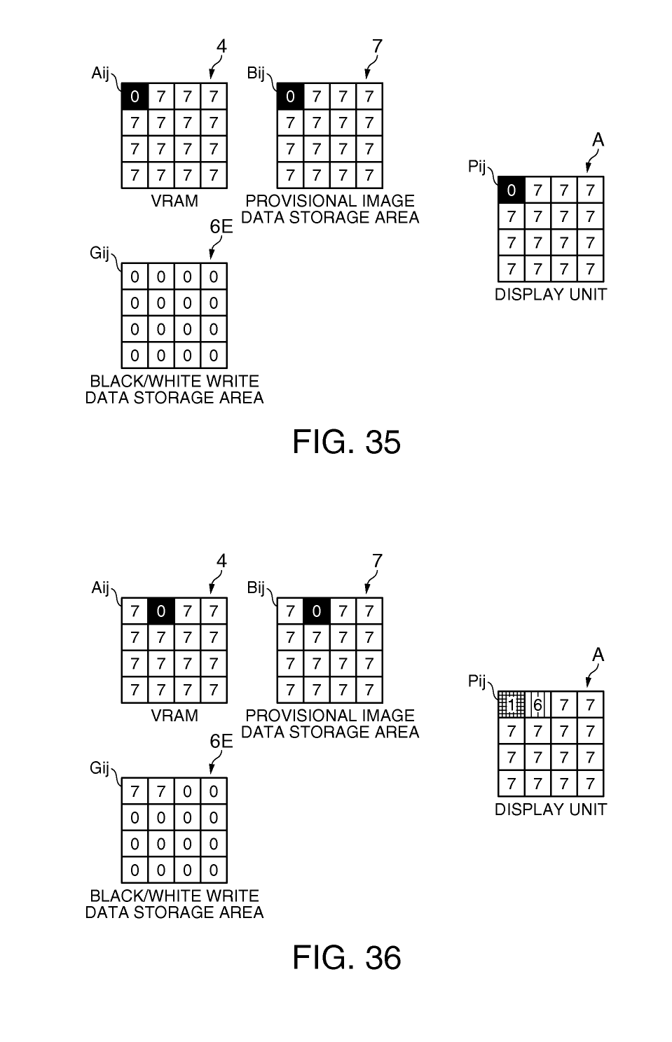

Next, a change in the content of the VRAM 4, a change in the content of the provisional image data storage area 7, and a change in the content of the black/white write data storage area 6E will be described with reference to FIGS. 35 and 36. When the control unit 3 writes image data into the VRAM 4 in a case where the state of the display of the display unit 1, the VRAM 4, the black/white write data storage area 6E and the provisional image data storage area 7 is the state shown in FIG. 35 (data writing process), the state of the VRAM 4 becomes the state shown in FIG. 36 in accordance with the image data.

When the pixel P11 is selected in Step S53 in the state of the VRAM 4 shown in FIG. 36, “Yes” is determined in Step S54, and “No” is determined in Step S56. Accordingly, “7” is written into the storage area G11 in Step S57, and the content of the storage area A11 is written into the storage area B11 in Step S58. Next, when the pixel P12 is selected, “Yes” is determined in Step S14, and “No” is determined in Step S16. Accordingly, “7” is written into the storage area G12 in Step S17, and the content of the storage area A12 is written into the storage area B12 in Step S18. Here, the contents of the provisional image data storage area 7 and the black/white write data storage area 6E are in the state shown in FIG. 36.

Thereafter, when the process of Step S63 is performed, in the pixel driving circuit corresponding to the pixel P11, the content of the storage area G11 is other than “0”, and the content of the storage area B11 is white, and accordingly, a voltage is applied to the data line 65 such that the electric potential of the pixel electrode 13a is −15 V with respect to the electric potential Vcom of the transparent electrode layer 32 when the scanning line 64 is selected. In addition, in the pixel driving circuit corresponding to the pixel P12, the content of the storage area G12 is other than “0”, and the content of the storage area B12 is black, and accordingly, a voltage is applied to the data line 65 such that the electric potential of the pixel electrode 13a is +15 V with respect to the electric potential Vcom of the transparent electrode layer 32 when the scanning line 64 is selected. In addition, for other pixels, since the content of the corresponding storage area in the black/white write data storage area 6E is “0”, a voltage is applied to the data line 65 such that a difference between the electric potential of the pixel electrode 13a and the electric potential Vcom of the transparent electrode layer 32 is 0 V when the scanning line 64 is selected. As above, when the voltage is applied to the data line 65, the white particles and the black particles move in the pixel, and the display of the display unit 1 is in the state shown in FIG. 36.

In the first embodiment, as areas in which data indicating whether or not an operation of changing the display state of the pixel is in the middle of the process is stored, two areas including the white write data storage area 6A and the black write data storage area 6B are arranged. However, in this embodiment, there is one area in which the data indicating whether the operation of changing the display state of the pixel is in the middle of the process, and accordingly, the storage capacity of the RAM 5 can be decreased.

### Modified Example 5

When rewriting for the pixel is performed along the table in the above-described second embodiment, for example, a halftone is displayed, after a voltage for allowing the pixel to be displayed in white (black) is applied a plurality of times, a voltage for allowing the pixel to be displayed in black (white) is applied a plurality of times. In the above-described second embodiment, in a case where, after a voltage for allowing the pixel to be displayed in white (black) is applied a plurality of times, a voltage for allowing the pixel to be displayed in black (white) is applied a plurality of times, the voltages are sequentially applied by using the table and the index. However, the invention is not limited to the configuration using a table.

To be more specific, in the RAM 5 of the display device according to this modified example, a white write data storage area 6A, a black write data storage area 6B, and a flag storage area 6F are arranged. In addition, the controller 2 has the same tables TB1 to TB12 as those of the second embodiment.

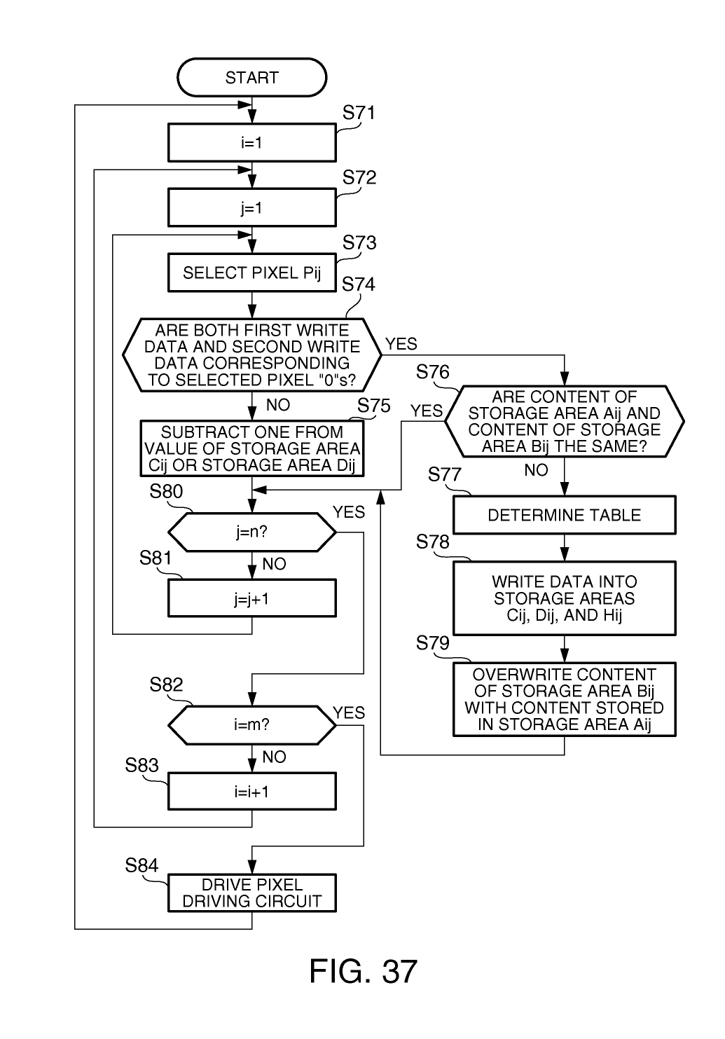

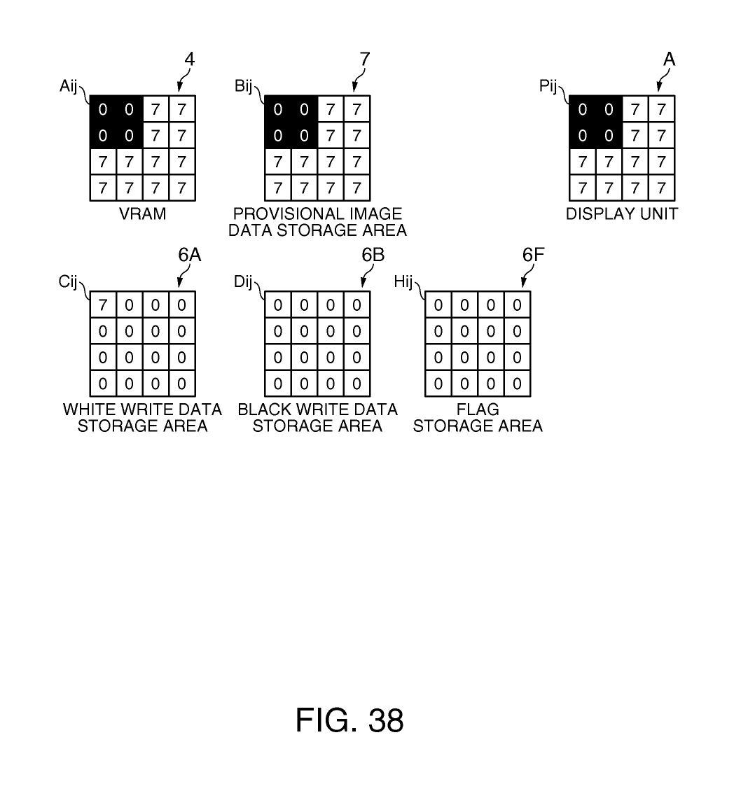

FIG. 37 is a flowchart showing the flow of the process performed by a controller 2 according to this modified example. FIG. 38 is a diagram showing the contents of the VRAM 4, the provisional image data storage area 7, the white write data storage area 6A, the black write data storage area 6B, and the flag storage area 6F according to this modified example as an example. In the flag storage area 6F, a flag that indicates which one of a voltage allowing the pixel to be displayed in white and a voltage for allowing the pixel to be displayed in black is applied first is stored. In the case where the value of the flag is “0”, it indicates that the voltage for allowing the pixel to be displayed in black is applied first. On the other hand, in a case where the value of the flag is “1”, it indicates that the voltage for allowing the pixel to be displayed in white is applied first. FIG. 38 shows the contents of the storage areas H11 to H44 corresponding to the pixels P11 to P44 in the flag storage area 6F.

When driving the pixel, the controller 2 performs the process shown in FIG. 37. First, the process of Steps S71 to S73 is the same process as that of Steps S11 to S13 of the first embodiment. Next, the writing state determining unit 202 determines whether or not both the first write data stored in the storage area Cij corresponding to the pixel Pij selected in Step S73 and the second write data stored in the storage area Dij are “0”s (Step S74). In a case where both the first write data stored in the storage area Cij corresponding to the pixel Pij and the second write data stored in the storage area Dij are “0”s, the writing state determining unit 202 proceeds to Step S76. On the other hand, either the first write data or the second write data is other than “0”, the writing state determining unit 202 proceeds to Step S75.

In Step S75, in a case where the value of the storage area Hij is “0”, the data updating unit 204 subtracts one from the value of the storage area Dij when the value of the storage area Dij is other than “0”. On the other hand, when the value of the storage area Dij is “0”, the data updating unit 204 subtracts one from the value of the storage area Cij. In a case where the value of the storage area Hij is “1”, the data updating unit 204 subtracts one from the value of the storage area Cij when the value of the storage area Cij is other than “0”. On the other hand, the data updating unit 204 subtracts one from the value of the storage area Dij when the value of the storage area Cij is “0”.

In Step S76, the rewriting determining unit 201 compares data stored in the storage area Aij and data stored in the storage area Bij with each other. Here, in a case where there is a difference therebetween (No in Step S76), the rewriting determining unit 201 determines a table out of tables TB1 to TB12 that is used for changing the gray scale of the pixel from the gray scale stored in the storage area Bij to the gray scale stored in the storage area Aij (Step S77).

Next, an update process for updating the data is performed, and data is written into the storage area Cij, the storage area Dij, and the storage area Hij based on the content of the table determined in Step S77 (Step S78). For example, in a case where the table TB5 is determined in Step S77, driving is performed such that a voltage used for allowing the pixel to be displayed in black is applied four times after a voltage used for allowing the pixel to be displayed in white is applied two times. In this case, “2” is stored in the storage area Cij, “4” is stored in the storage area Dij, and “1” is stored in the storage area Hij. On the other hand, in a case where the table TB2 is determined in Step S77, driving is performed such that a voltage allowing the pixel to be displayed in black is applied four times. In this case, “0” is stored in the storage area Cij, “4” is stored in the storage area Dij, and “0” is stored in the storage area Hij. In addition, although there is no table among the tables TB1 to TB12, a table in which, after a voltage allowing the pixel to be displayed in black a plurality of times, a voltage allowing the pixel to be displayed in white is applied a plurality of times, for example, in a case where driving is performed such that, after a voltage allowing the pixel to be displayed in black two times, a voltage allowing the pixel to be displayed in white is applied four times, “4” is stored in the storage area Cij, “2” is stored in the storage area Dij, and “0” is stored in the storage area Hij.

Next, in Step S79, the provisional image updating unit 205 overwrites the content of the storage area Bij with the content stored in the storage area Aij. The following process of Steps S80 to S83 is the same process as that of Steps S19 to S22 of the first embodiment.

In Step S84, the writing control unit 203 drives the pixel driving circuit by controlling the scanning line driving circuit 53 and the data line driving circuit 54. Here, in a case where the value of the storage area Hij is “0”, when the value of the storage area Dij is other than “0”, a voltage for allowing the pixel to be displayed in black is applied to the pixel Pij. On the other hand, when the value of the storage area Dij is “0”, and the value of the storage area Cij is other than “0”, a voltage for allowing the pixel to be displayed in white is applied to the pixel Pij. In a case where the value of the storage area Hij is “1”, when the value of the storage area Cij is other than “0”, a voltage for allowing the pixel to be displayed in white is applied to the pixel Pij. On the other hand, when the value of the storage area Cij is “0” and the value of the storage area Dij is other than “0”, a voltage for allowing the pixel to be displayed in black is applied to the pixel Pij.

As above, also in this modified embodiment, similarly to a case where a table is used, the gray scale of the pixel can be controlled by applying the voltage for allowing the pixel to be displayed in black and the voltage for allowing the pixel to be displayed in white.

### Modified Example 6

In the above-described second embodiment, although the storage area of the index is arranged for each pixel, the invention is not limited to such a configuration. For example, the storage area of the index may be arranged for each row of the pixels arranged in a plurality of rows and a plurality of columns. Hereinafter, a specific configuration of this modified example will be described. A display device according to this modified example, the configuration of an index storage area 6D and the flow of the process performed by a controller 2 are different from those of the second embodiment, and the other configurations are the same as those of the second embodiment.

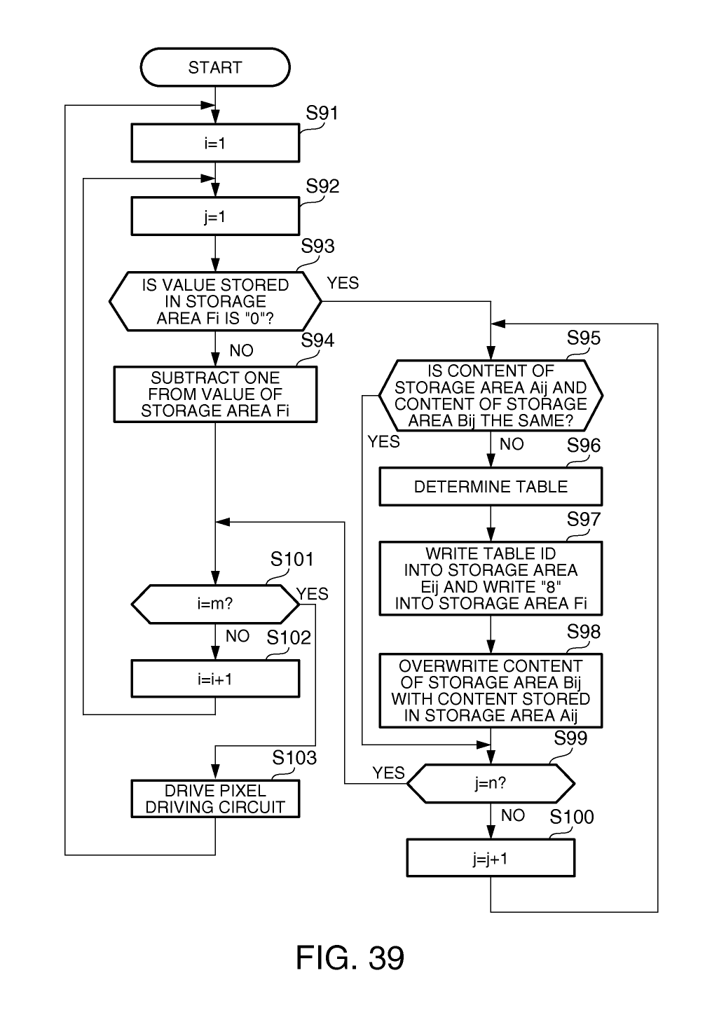

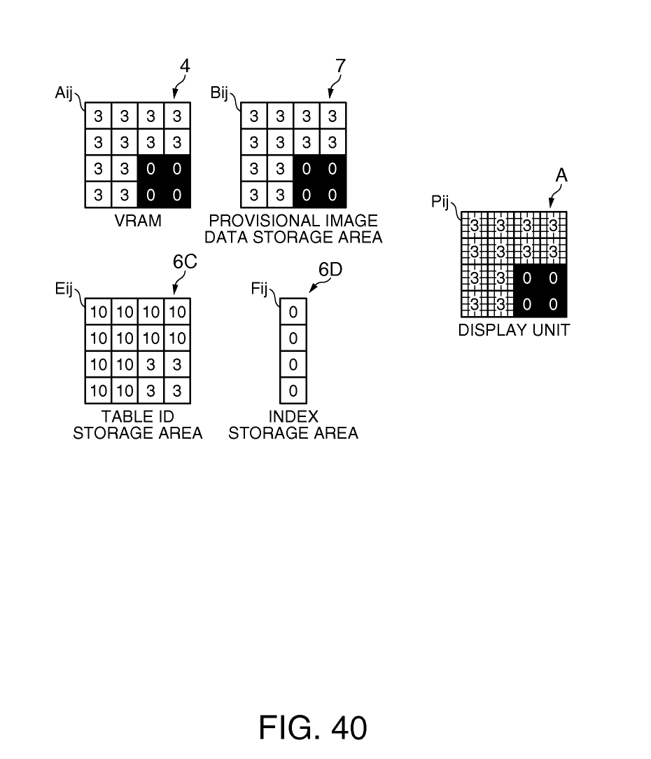

FIG. 39 is a flowchart showing the flow of the process performed by the controller 2 according to this modified example. FIG. 40 is a diagram showing the contents of the VRAM 4, the provisional image data storage area 7, the table ID storage area 6C, and the index storage area 6D as an example. As shown in FIG. 40, in the index storage area 6D according to this modified example, the storage area is not arranged for each pixel, but the storage area is arranged for every row of pixels configuring a plurality of rows and a plurality of columns (for every scanning line). FIG. 40 shows the content of the storage area Fi corresponding to the rows of the first row to the fourth row. In the storage area F1, a number indicating the index that is referred to in the table for the pixels of the first row is stored.

When driving the pixel, the controller 2 performs the process shown in FIG. 39. First, the process of Steps S91 and S92 is the same process as that of Steps S11 and S12 of the first embodiment. Next, the writing state determining unit 202 determines whether or not the value of the index stored in the storage area Fi is “0” (Step S93). For example, in a case where the value of the variable i is “1”, it is determined whether or not the value of the index stored in the storage area F1 is “0”. In a case where the content of the storage area Fi is “0” (Yes in Step S93), the writing state determining unit 202 proceeds to Step S95. On the other hand, in a case where the content of the storage area Fi is other than “0” (No in Step S93), the writing state determining unit 202 proceeds to Step S94. In Step S94, the data updating unit 204 subtracts one from the value of the storage area Fi.

In Step S95, the rewriting determining unit 201 compares data stored in the storage area Aij and data stored in the storage area Bij with each other. Here, in a case where there is a difference therebetween (No in Step S95), the rewriting determining unit 201 determines a table out of tables TB1 to TB12 that is used for changing the gray scale of the pixel Pij from the gray scale stored in the storage area Bij to the gray scale stored in the storage area Aij (Step S96). Next, an update process for updating data is performed, the table ID of the table determined in Step S96 is written into the storage area Eij, and “8” is written into the storage area Fi (Step S97). In addition, the provisional image updating unit 205 overwrites the content of the storage area Bij with the content stored in the storage area Aij (Step S98).

Next, the controller 2 determines whether or not the value of the variable j is the number n of the data lines in Step S99. Here, in a case where the variable j is not the same as n (No in Step S99), one is added to the value of the variable j (Step S100), and the process proceeds to Step S95. On the other hand, in a case where the value of the variable j is n, it is determined whether or not the value of the variable i is the same as the number m of scanning lines. Here, in a case where the value of the variable i is not m (No in Step S101), one is added to the value of the variable i (Step S102), and the process proceeds to Step S92. On the other hand, in a case where the value of the variable i is m, the writing control unit 203 drives the pixel driving circuit by controlling the scanning line driving circuit 53 and the data line driving circuit 54 (Step S103).

In Step S103, the writing control unit 203 drives the pixel driving circuit by controlling the scanning line driving circuit 53 and the data line driving circuit 54. Here, the driving of a pixel will be described in a case where the value, for example, stored in the storage area F1 is “8” as an example.

For example, in a case where a pixel P11 is driven, the pixel P11 is a pixel located in the first row, and accordingly, the storage area F1 corresponding to the first row is referred to. In a case where the value stored in the storage area E11 is “10”, the content of the storage area F1 is “8”, and accordingly, a voltage for allowing the pixel to be displayed in white is applied to the pixel P11 based on data “w” associated with the index “8” in the Table TB10. In addition, in a case where a pixel P12 is driven, the pixel P12 is a pixel located in the first row, and accordingly, the storage area F1 corresponding to the first row is referred to. Here, in a case where the value stored in the storage area E12 is “3”, the content of the storage area F1 is “8”, and accordingly, a voltage for allowing the pixel to be displayed in black is applied to the pixel P12 based on the data “b” that is associated with the index “8” in the table TB3.

As above, according to this modified example, the index is not stored for each pixel, and therefore, the storage capacity of the RAM 5 can be decreased.

### Modified Example 7

In the above-described second embodiment, although the storage area of the index is arranged for each pixel, the invention is not limited to such a configuration. For example, it may be configured such that vertical two×horizontal two pixels is set as one block, and the storage area of the index may be arranged for each block. Hereinafter, a specific configuration of this modified example will be described. In a display device according to this modified example, the configuration of an index storage area 6D and the flow of the process performed by a controller 2 are different from those of the second embodiment, and the other configurations are the same as those of the second embodiment.

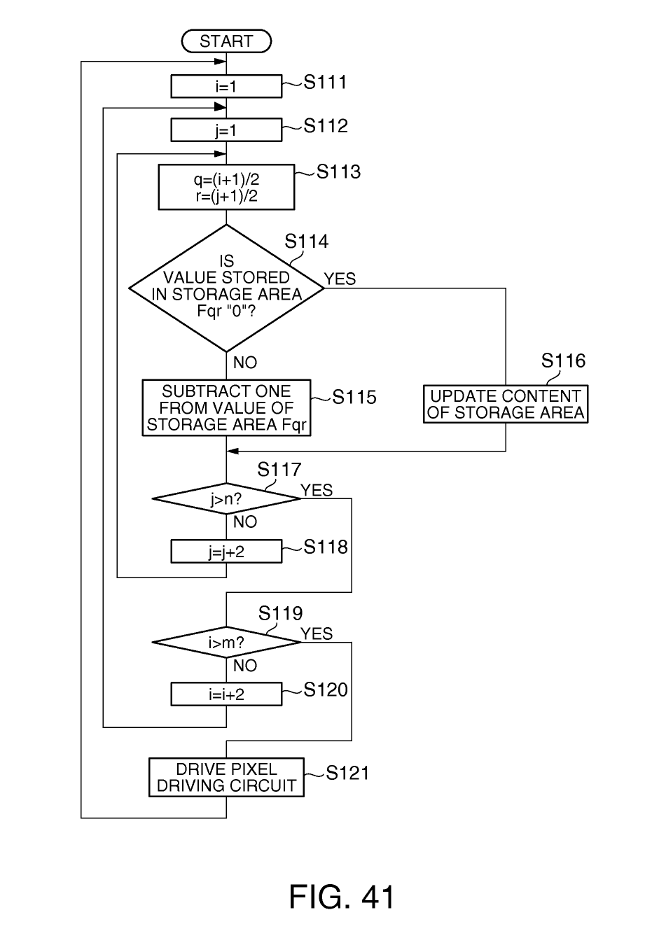

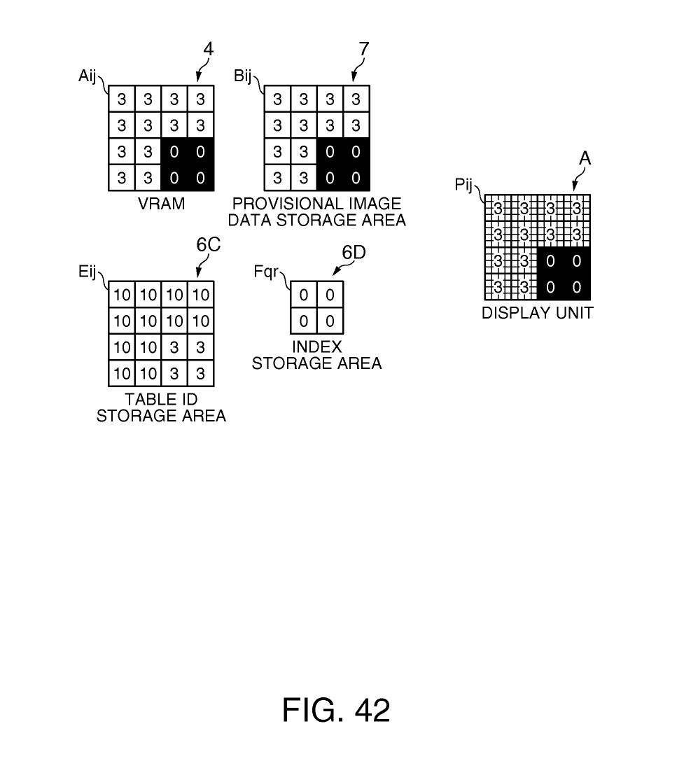

FIG. 41 is a flowchart showing the flow of the process performed by the controller 2 according to this modified example. FIG. 42 is a diagram showing the contents of the VRAM 4, the provisional image data storage area 7, the table ID storage area 6C, and the index storage area 6D as an example. As shown in FIG. 42, in the index storage area 6D according to this modified example, the storage area is not arranged for each pixel, but the index storage area Fqr is arranged for each block configured by vertical two×horizontal two pixels. The storage area Fqr represents one storage area. Here, q included in subscript represents the row number of the storage area arranged in a matrix, r represents the column number. Hereinafter, in a case where the index storage area is specified in the description, for example, a storage area located in the first row and the first column is referred to as a storage area F11. In FIG. 42, in the storage area F11, a number indicating the index to be referred to in the table for the pixels P11, P12, P21, and P22 is stored. In the storage area F12, a number indicating the index to be referred to in the table for the pixels P13, P14, P23, and P24 is stored. In addition, in the storage area F21, a number indicating the index to be referred to in the table for the pixels P31, P32, P41, and P42 is stored. In the storage area F22, a number indicating the index to be referred to in the table for the pixels P33, P34, P43, and P44 is stored.

When driving the pixel, the controller 2 performs the process shown in FIG. 41. First, the process of Steps S111 and S112 is the same process as that of Steps S11 and S12 of the first embodiment. Next, the writing state determining unit 202 sets variables such that q=(i+1)/2 and r=(j+1)/2 (Step S113). Thereafter, the writing state determining unit 202 determines whether or not the value of the index stored in the storage area Fqr is “0” (Step S114). For example, in a case where the value of the variable q is “1”, and the value of the variable r is “1”, it is determined whether or not the value of the index stored in the storage area F11 is “0”.

In a case where the content of the storage area Fqr is “0” (Yes in Step S114), the writing state determining unit 202 proceeds to Step S116. On the other hand, in a case where the content of the storage area Fqr is other than “0” (No in Step S114), the process proceeds to Step S115. In Step S115, the data updating unit 204 subtracts one from the value of the storage area Fqr.

On the other hand, in Step S116, the data stored in the storage areas corresponding to the periphery pixels of the pixel Pij and the pixel Pij is updated. To be more specific, data stored in the storage area Aij and data stored in the storage area Bij are compared with each other. Here, in a case where there is a difference therebetween, the rewriting determining unit 201 determines a table out of the tables TB1 to TB12 that is used for changing the gray scale of the pixel Pij from the gray scale stored in the storage area Bij to the gray scale stored in the storage area Aij. Next, an update process in which data is updated is performed, and the table ID of the determined table is written into the storage area Eij, and “8” is written into the storage area Fij. In addition, the provisional image updating unit 205 overwrites the content of the storage area Bij with the content stored in the storage area Aij. Furthermore, here, the process of updating the content of the storage area is similarly performed also for a pixel of i+1 from the pixel Pij, a pixel of j+1 from the pixel Pij, and a pixels of i+1 and j+1 from the pixel Pij.

Next, the controller 2 determines whether or not the value of the variable j exceeds the number n of the data lines in Step S117. Here, in a case where the value of the variable j does not exceed n (No in Step S117), two is added to the value of the variable j (Step S118), and the process proceeds to Step S113. On the other hand, in a case where the value of the variable j exceeds n (Yes in Step S117), it is determined whether the value of the variable i exceeds the number m of the scanning lines. Here, in a case where the value of the variable i does not exceed m (No in Step S119), two is added to the value of the variable i (Step S120), and the process proceeds to Step S112. On the other hand, in a case where the value of the variable i exceeds m (Yes in Step S119), the writing control unit 203 drives the pixel driving circuit by controlling the scanning line driving circuit 53 and the data line driving circuit 54 (Step S121).

In Step S121, the writing control unit 203 drives the pixel driving circuit by controlling the scanning line driving circuit 53 and the data line driving circuit 54.

Here, for example, the driving of a pixel will be described in a case where the value stored in the storage area Fqr is “8”.

For example, in a case where the value stored in the storage area Eij is “10, variables are set such that q=(i+1)/2 and r=(j+1)/2, and the storage area Fqr is referred to. Here, in a case where the content of the storage area Fqr is “8”, a voltage for allowing the pixel to be displayed in white is applied to the pixel Pij based on the data “w” that is associated with the index “8” in the table TB10. In addition, for example, in a case where the value stored in the storage area Eij is “3”, variables are set such that q=(i+1)/2 and r=(j+1)/2, and the storage area Fqr is referred to. Here, in a case where the content of the storage area Fqr is “8”, a voltage for allowing the pixel to be displayed in black is applied to the pixel Pij based on the data “b” that is associated with the index “8” in the table TB3.

As above, according to this modified example, the index is not stored for each pixel, and accordingly, the storage capacity of the RAM 5 can be decreased.

### Modified Example 8

In the above-described first embodiment, in a case where the value of the first write data is other than “0”, a voltage for allowing the pixel to be displayed in white is applied to the pixel electrode 13a. On the other hand, in a case where the value of the second write data is other than “0”, a voltage for the pixel to be displayed in black is applied to the pixel electrode 13a. However, the configuration for applying the voltage to the pixel electrode 13a is not limited thereto.

For example, in a case where the value of the first write data is “1”, a voltage may be applied to the data line 65 such that an electric potential difference between the pixel electrode 13a and the transparent electrode layer 32 is 0 V. On the other hand, in a case where the value of the second write data is “1”, a voltage may be applied to the data line 65 such that an electric potential difference between the pixel electrode 13a and the transparent electrode layer 32 is 0 V.

### Modified Example 9

In a case where the pixel is driven by using a table, the number of indices of the table is not limited to that of the above-described second embodiment. For example, the number of the indices may be a number exceeding “8” or a number less than “8”.

### Modified Example 10

In the above-described embodiment, when the values of the first write data and the second write data are “0” by gradually decreasing the first write data and the second write data, the electric potential difference between the pixel electrode 13a and the transparent electrode layer 32 is regarded as 0 V. However, when the values of the data are values set in advance by gradually increasing the first write data and the second write data, the electric potential difference between the pixel electrode 13a and the transparent electrode layer 32 may be configured to be 0 V.

In addition, regarding the electrophoretic particles, in the above-described embodiments, the black electrophoretic particles are positively charged, and the white electrophoretic particles are negatively charged. However, a configuration may be employed in which the black electrophoretic particles are negatively charged, and the white electrophoretic particles are positively charged. In such a configuration, the electric potential of the pixel electrode 13a may be set to −15 V with respect to the electric potential Vcom of the transparent electrode layer 32 in a case where the pixel is allowed to be displayed in white, and the electric potential of the pixel electrode 13a may be set to +15 V with respect to the electric potential Vcom of the transparent electrode layer 32 in a case where the pixel is allowed to be displayed in black.

### Modified Example 11

In the above-described embodiments, a configuration is employed in which the black electrophoretic particles are positively charged, and the white electrophoretic particles are negatively charged. However, a configuration may be employed in which the black electrophoretic particles are negatively charged, and the white electrophoretic particles are positively charged. In addition, monochrome display is performed by using two types of the white electrophoretic particles and the black electrophoretic particles as the electrophoretic particles. However, the colors of the electrophoretic particles are not limited to white and black, and thus may be other colors such as red, blue, and green.

In addition, in the above-described embodiments, although the display device uses an electrophoretic system, the display device is not limited thereto. As the display system of the display device, for example, a cholesteric liquid crystal, an electrochromic, an electron power fluid, or the like may be used, as long as it displays an image by applying a voltage to the pixel over a plurality of frames.

Furthermore, the electrophoretic layer 20 is not limited to the configuration including the microcapsules 21 and may have a configuration in which a dispersion medium and electrophoretic particles are stored in spaces divided by a partition wall.

In addition, in the above-described embodiments, the controller 2 and the control unit 3 are separately configured. However, a part of the function realized by the controller 2 may be realized by the control unit 3. Furthermore, the controller 2 and the control unit 3 may be arranged on one semiconductor chip as a control unit.

The entire disclosure of Japanese Patent Application No. 2010-194905, filed Aug. 31, 2010 is expressly incorporated by reference herein.

What is claimed is:

1. A control device for a display device in which each of a plurality of pixels is configured by a first electrode, a display element, and a second electrode by interposing the display element between a first substrate in which the first electrodes are disposed and a second substrate in which the second electrodes are disposed in correspondence with the plurality of pixels,
wherein a gray scale of the pixel is changed by a write operation in which a voltage is applied to the pixel a plurality of times, and
wherein, within one frame period, a voltage is applied to a first pixel, of which a gray scale is changed to a high density side, with the first electrode of the first pixel being set to one of positive polarity and negative polarity with respect to the second electrode, and a voltage is applied to a second pixel, of which a gray scale is changed to a low density side, with the first electrode of the second pixel being set to polarity opposite to the one of positive polarity and negative polarity with respect to the second electrode,
the control device comprising:
a specifying unit that specifies change pixels, of which gray scales are changed, among the plurality of pixels by comparing image data written into a memory and provisional image data representing a provisional image to be displayed on the display device by the write operation that is in the middle of the process; and
an update unit that starts the write operation for the change pixel so as to have a gray scale determined based on the image data in a case where the change pixel is not in the middle of the process of the write operation, and, after completion of the write operation that is in the middle of the process, starts the write operation for the change pixel so as to have a gray scale determined based on the image data in a case where the change pixel is in the middle of the process of the write operation.

2. The control device for a display device according to claim 1,
wherein a value indicating whether or not the change pixel is in the middle of the write operation is stored in a storage area for each of the change pixels,
wherein the value stored in the storage area is decreased or increased every time a plurality of frames, which is predetermined, elapses, and
wherein, in a case where the value stored in the storage area is a predetermined value, the write operation for the change pixel corresponding to the storage area ends, and, in a case where the value stored in the storage area is not the predetermined value, the write operation for the change pixel corresponding to the storage area is continued.

3. The control device for a display device according to claim 1, wherein the specifying unit specifies the change pixel every time a plurality of frames elapses.

4. The control device for a display device according to claim 1,
wherein the number of times of applying a first voltage that is applied for changing the gray scale of the change pixel to the high density side, the number of times of applying a second voltage that is applied for changing the gray scale of the change pixel to the low density side, and a flag that represents the voltage that is applied first out of the first voltage and the second voltage are stored in the storage area for each pixel,
wherein the first voltage is applied to the change pixel corresponding to the storage area in accordance with the number of times of applying of the first voltage that is stored in the storage area, and then the second voltage is applied to the change pixel corresponding to the storage area in accordance with the number of times of applying of the second voltage that is stored in the storage area in a case where the flag stored in the storage area indicates that the first voltage is applied first, and
wherein the second voltage is applied to the change pixel corresponding to the storage area in accordance with the number of times of applying of the second voltage that is stored in the storage area, and then the first voltage is applied to the change pixel corresponding to the storage area in accordance with the number of times of applying of the first voltage that is stored in the storage area, in a case where the flag stored in the storage area indicates that the second voltage is applied first.

5. The control device for a display device according to claim 1,
wherein the number of times of applying a voltage applied for changing the gray scale of the change pixel is stored in the storage area for each change pixel,
wherein the change pixel is determined as the first pixel or the second pixel based on the provisional image data,
wherein a first voltage that is used for changing the gray scale of the change pixel to a high density side is applied to the change pixel in accordance with the number of times of applying the voltage that is stored in the storage area corresponding to the change pixel in a case where the change pixel is the first pixel, and
wherein a second voltage that is used for changing the gray scale of the change pixel to a low density side is applied to the change pixel in accordance with the number of times of applying the voltage that is stored in the storage area corresponding to the change pixel in a case where the change pixel is the second pixel.

6. The control device for a display device according to claim 1, further comprising:
a control unit that applies a voltage to the pixel based on a table in which a voltage to be applied for each of the plurality of times in the write operation is determined.

7. The control device for a display device according to claim 6,
wherein the pixels are arranged in a plurality of rows and a plurality of columns,
wherein a value that indicates whether or not the pixels in a row are in the middle of the write operation is stored in a storage area for each row,
wherein the value stored in the storage area is decreased or increased every time one frame elapses, and
wherein the write operation for the change pixel in a row corresponding to the storage area ends in a case where the value stored in the storage area is a predetermined value, and the write operation for the change pixel in the row corresponding to the storage area is continued in a case where the value stored in the storage area is not the predetermined value.

8. The control device for a display device according to claim 6,
wherein the pixels are arranged in a plurality of rows and a plurality of columns,
wherein a value that indicates whether or not the pixels within a block are in the middle of the write operation is stored in a storage area for each block acquired by dividing the pixels into a plurality of blocks,
wherein the value stored in the storage area is decreased or increased every time one frame elapses, and
wherein the write operation for the change pixel in a block corresponding to the storage area ends in a case where the value stored in the storage area is a predetermined value, and the write operation for the change pixel in the block corresponding to the storage area is continued in a case where the value stored in the storage area is not the predetermined value.

9. The control device for a display device according to claim 1, wherein, in the pixel for which the write operation ends, an electric potential of the first electrode is controlled to be the same as that of the second electrode after the end of the write operation.

10. The control device for a display device according to claim 1, wherein, in a case where the write operation is not performed for all the plurality of pixels, supply of power to a circuit that applies a voltage to the pixels is blocked.

11. A display device in which each of a plurality of pixels is configured by a first electrode, a display element, and a second electrode by interposing the display element between a first substrate in which the first electrodes are disposed and a second substrate in which the second electrodes are disposed in correspondence with the plurality of pixels,
wherein a gray scale of the pixel is changed by a write operation in which a voltage is applied to the pixel a plurality of times, and
wherein, within one frame period, a voltage is applied to a first pixel, of which a gray scale is changed to a high density side, with the first electrode of the first pixel being set to one of positive polarity and negative polarity with respect to the second electrode, and a voltage is applied to a second pixel, of which a gray scale is changed to a low density side, with the first electrode of the second pixel being set to polarity opposite to the one of positive polarity and negative polarity with respect to the second electrode,
the display device comprising:
a specifying unit that specifies change pixels, of which gray scales are changed, among the plurality of pixels by comparing image data written into a memory and provisional image data representing a provisional image to be displayed on the display device by the write operation that is in the middle of the process; and
an update unit that starts the write operation for the change pixel so as to have a gray scale determined based on the image data in a case where the change pixel is not in the middle of the process of the write operation, and, after completion of the write operation that is in the middle of the process, starts the write operation for the change pixel so as to have a gray scale determined based on the image data in a case where the change pixel is in the middle of the process of the write operation.

12. The display device according to claim 11, further comprising:
a control unit that applies a voltage to the pixel based on a table in which a voltage to be applied for each of the plurality of times in the write operation is determined.

13. A method of controlling a display device in which each of a plurality of pixels is configured by a first electrode, a display element, and a second electrode by interposing the display element between a first substrate in which the first electrodes are disposed and a second substrate in which the second electrodes are disposed in correspondence with the plurality of pixels,
wherein a gray scale of the pixel is changed by a write operation in which a voltage is applied to the pixel a plurality of times, and
wherein, within one frame period, a voltage is applied to a first pixel, of which a gray scale is changed to a high density side, with the first electrode of the first pixel being set to one of positive polarity and negative polarity with respect to the second electrode, and a voltage is applied to a second pixel, of which a gray scale is changed to a low density side, with the first electrode of the second pixel being set to polarity opposite to the one of positive polarity and negative polarity with respect to the second electrode,
the method comprising:
specifying change pixels, of which gray scales are changed, among the plurality of pixels by comparing image data written into a memory and provisional image data representing a provisional image to be displayed on the display device by the write operation that is in the middle of the process; and
starting the write operation for the change pixel so as to have a gray scale determined based on the image data in a case where the change pixel is not in the middle of the process of the write operation, and, after completion of the write operation that is in the middle of the process, starting the write operation for the change pixel so as to have a gray scale determined based on the image data in a case where the change pixel is in the middle of the process of the write operation.

14. The method of controlling a display device according to claim 13, further comprising:
applying a voltage to the pixel based on a table in which a voltage to be applied for each of the plurality of times in the write operation is determined.
